(19) United States
(12) Patent Application Publication
(10) Pub. No.: US 2006/0285140 A1
(43) Pub. Date: Dec. 21, 2006

(54) Image forming apparatus with selective display of image data

(76) Inventor: Homare Ehara, Kanagawa (JP)

Correspondence Address: HARNESS, DICKEY & PIERCE, P.L.C., P.O. BOX 8910, RESTON, VA, 20195, US

(21) Appl. No.: 11/442,339

(22) Filed: May 30, 2006

(30) Foreign Application Priority Data
May 30, 2005 (JP) 2005-157514

(51) Int. Cl. G06F 3/12

(52) U.S. Cl. 358/1.13; 358/1.15

(57) ABSTRACT

An image forming apparatus includes: a memory configured to store image data; a display unit to display at least one of information and a view of image data; a condition setting unit to receive designating information by which a designation is made of at least a subset of the image data stored in the memory; a printing unit configured to print an image, corresponding to the designated image data, on a recording medium; and a controller configured to assign printed information to the designated image data stored in the memory when an image of the designated image data is printed by the printing unit, and to selectively display a view of the designated image data on the display unit.

### PRIORITY STATEMENT

This application claims priority over Japanese patent application No. 2005-157514 filed on May 30, 2005 in the Japan Patent Office, the entire contents of which is hereby incorporated by reference herein.

### BACKGROUND

An electronic document management system may include an image data storing function. Such electronic document management system includes an image forming apparatus, for example.

Such electronic document management system (e.g., image forming apparatus) may include a thumbnail or preview display function for image data stored in the electronic document management system, by which stored image data can be displayed as thumbnail or preview on a display unit.

Such thumbnail or preview display function make it easy for a user confirming contents of stored image data, confirming image data to be printed, and confirming image data to be eliminated from stored image data, for example. Typically, such user has an access right to image data that is the subject of the previous display function.

Although such thumbnail or preview display function may improve usability for a legitimate user, a person lacking an access right to the image data nonetheless may see such thumbnail or preview accidentally or intentionally, by which information security may be breached.

### SUMMARY

At least one embodiment of the present invention relates to an image forming apparatus that may include a memory, a condition setting unit, a printing unit, and a controller. The memory stores image data. The display unit displays at least one of information and a view of image data. The condition setting unit receives designating information by which a designation is made of at least a subset of the image data stored in the memory. The printing unit prints an image, corresponding to the designated image data, on a recording medium. And the controller can assign printed information to the designated image data stored in the memory when an image of the designated image data is printed by the printing unit, and can selectively display a view of the designated image data on the display unit.

Additional features and advantages of the present invention will be more fully apparent from the following detailed description of example embodiments, the accompanying drawings and the associated claims.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic view of an image forming apparatus according to an example embodiment of the present invention;

FIG. 2 is a schematic cross-sectional view (according to an example embodiment of the present invention) of a scanner and automatic document feeder of an image forming apparatus in FIG. 1;

FIG. 3 is a schematic cross-sectional view of a printer (according to an example embodiment of the present invention) of an image forming apparatus in FIG. 1;

FIG. 4 is a block diagram of an image processing system (according to an example embodiment of the present invention) of an image forming apparatus in FIG. 1;

FIG. 5 is a block diagram (according to an example embodiment of the present invention) of an image data interface controller CDIC shown in FIG. 4;

FIG. 6 is a block diagram (according to an example embodiment of the present invention) of an image memory access controller IMAC shown in FIG. 4;

FIG. 7 is a block diagram (according to an example embodiment of the present invention) of an image data processor IPP shown in FIG. 4;

FIG. 8 is a block diagram (according to an example embodiment of the present invention) of a scanned-image processor and printer image quality processor of an image data processor IPP shown in FIG. 4;

FIG. 9 is a schematic view of an operation panel (according to an example embodiment of the present invention) for an image forming apparatus shown in FIG. 1;

FIG. 10 is a block diagram of an input/output process system (according to an example embodiment of the present invention) related to an operation panel shown in FIG. 9;

FIGS. 11A and 11B (or, collectively, FIG. 11) are flow charts for explaining (according to an example embodiment of the present invention) an image processing control conducted by a system controller shown in FIG. 4 with an operation panel;

FIG. 12 is a schematic view (according to an example embodiment of the present invention) of “copy server” input view displayed on a LCD touch panel shown in FIG. 9;

FIG. 13 is a flow chart for explaining (according to an example embodiment of the present invention) a process of data registration shown in FIG. 11;

FIG. 14 is a flow chart for explaining (according to an example embodiment of the present invention) a process of document scan shown in FIG. 11;

FIGS. 15A & 15B (or, collectively, FIG. 15), 16, and 17 show flow charts for explaining (according to an example embodiment of the present invention) a process of file selection shown in FIG. 11; and

FIG. 18 is a schematic screen view (according to an example embodiment of the present invention) showing a file list on a LCD touch panel shown in FIG. 9.

### DETAILED DESCRIPTION OF EXAMPLE EMBODIMENTS

It will be understood that if an element or layer is referred to as being “on,” “against,” “connected to” or “coupled to” another element or layer, then it can be directly on, against connected or coupled to the other element or layer, or intervening elements or layers may be present. In contrast, if an element is referred to as being “directly on”, “directly connected to” or “directly coupled to” another element or layer, then there are no intervening elements or layers present. Like numbers refer to like elements throughout. As used herein, the term “and/or” includes any and all combinations of one or more of the associated listed items.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the disclosure of this present invention is not intended to be limited to the specific terminology so selected and it is to be understood that each specific element includes all technical equivalents that operate in a similar manner.

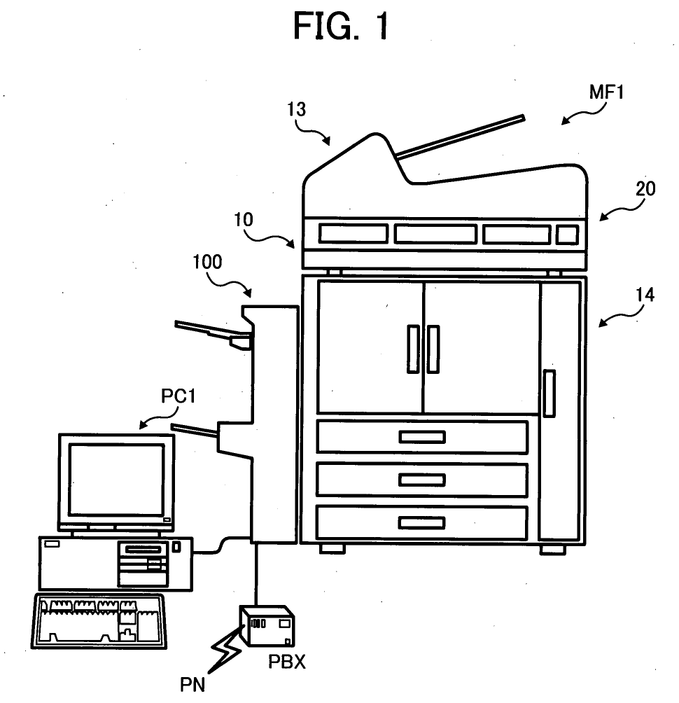

Referring now to the drawings, wherein like reference numerals designate identical or corresponding parts throughout the several views, an image forming apparatus according to an example embodiment is described with particular reference to FIGS. 1 to 3.

FIG. 1 is a schematic view of an image forming apparatus MF1 according to an example embodiment of the present invention. The image forming apparatus MF1 includes a multi-functional image forming apparatus, for example.

The image forming apparatus MF1 includes an automatic document feeder (ADF) 13, an operation panel 20, a scanner 10, a printer 14, and a finisher 100. The ADF 13 can be integrated with the scanner 10, for example.

The image forming apparatus MF1 can be configured to make the operation panel 20, scanner 10, ADF 13, and finisher 100 detachable from the printer 14, for example.

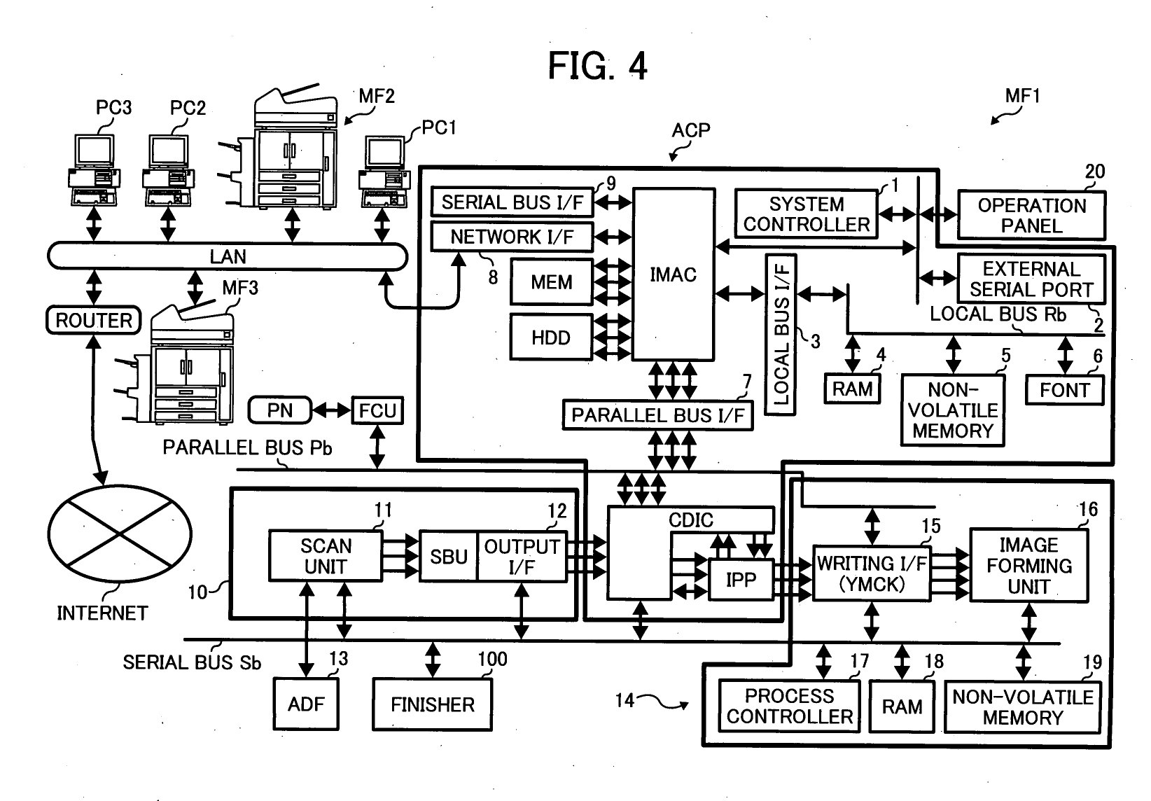

The scanner 10 includes a control board, which has a controller and driver. The image forming apparatus MF1 includes an image processing unit ACP (see FIG. 4) as a control board. The scanner 10 scans one or more documents and communicates information with the image forming apparatus MF1 for printing an image with the printing unit 14, for example.

The image processing unit ACP (see FIG. 4) is connected to a LAN (local area network) connected to a personal computer PC as shown in FIG. 4.

A facsimile control unit FCU (see FIG. 4) is connected to a phone line PN used for facsimile communication line.

After recording an image on a recording medium (e.g., sheet) with the printer 14, the recording medium (e.g., sheet) is ejected to the finisher 100.

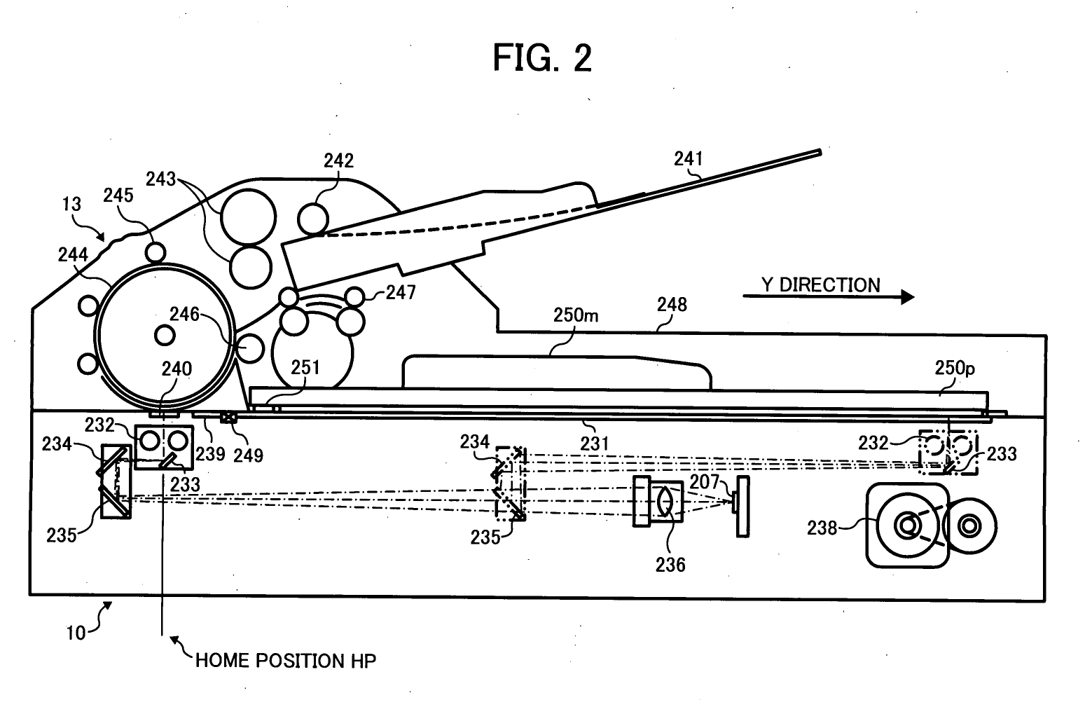

FIG. 2 shows a schematic sectional view (according to an example embodiment of the present invention) of the scanner 10 and ADF 13, by which one or more documents can be scanned.

The scanner 10 includes a contact glass 231, an illumination unit 232, a first mirror 233, a second mirror 234, a third mirror 235, a lens 236, a CCD (charge coupled device) 207, and a motor 238.

One or more documents can be scanned as below. At first, a document sheet is placed on the contact glass 231 of the scanner 10. Then, the illumination unit 232 illuminates the document sheet by moving in a sub-scanning direction y of the document sheet. Then, a reflected light from the document sheet is reflected by the first mirror 233.

The illumination unit 232 and first mirror 233 can be installed in a first carriage (not shown), which can be moved in the sub-scanning direction (i.e., y direction in FIG. 2) at a first speed.

A second carriage (not shown), which can be moved in the sub-scanning direction (i.e., y direction in FIG. 2) at a second speed, includes the second mirror 234 and third mirror 235, wherein the second speed is set to one half of the first speed, for example.

The first mirror 233 reflects the light to the second mirror 234. Then, the second mirror 234 reflects the light to the third mirror 235, which is a downward direction in FIG. 2. The third mirror 235 reflects the light to the lens 236 in the sub-scanning direction (i.e., y direction in FIG. 2). The light focused by the lens 236 irradiates the CCD 207, and then the light is converted into an electrical signal.

The first and second carriage can be moved in bi-directionally in the sub-scanning direction (i.e., y direction in FIG. 2) by the motor 238.

The above-described scanner 10 is a flat head type scanner, which scans a document sheet placed on the contact glass 231 with the illumination unit 232 and first mirror 233, and focuses the light on the CCD 207.

The scanner 10 can also include a sheet-through type scanner, in which the first carriage stays at a home position (or standby position) HP shown in FIG. 2.

When the first carriage stays at the home position HP, the first mirror 233 is placed at a scan position, which faces a scan glass 240 functioning as a scanning window for the sheet-through type. The ADF 13 is provided above the scan glass 240, and a transport drum 244 of the ADF 13 faces the scan glass 240.

A document sheet placed on a sheet tray 241 of the ADF 13 is sandwiched by a pickup roller 242 and a registration roller 243, and then fed to a sheet path between the transport drum 244 and a press roller 245.

The document sheet closely contacts the transport drum 244 and passes over the scan glass 240, and ejected to an ejection tray 248 by ejection rollers 246 and 247.

When the document sheet passes over the scan glass 240, the illumination unit 232 illuminates a document through the scan glass 240 with a light beam.

The light reflected from the document sheet is focused on the CCD 207 via an optical unit including first mirror 233. Then, the light is converted into an electrical signal (i.e., electrical signal for red, green, and blue color)

The transport drum 244 has a surface colored in white, wherein the surface of the transport drum 244 is used as a reference white face.

As shown in FIG. 2, a reference white plate 239 and a position sensor 249 are provided between the scan glass 240 and a scale 251, which defines an edge of the document sheet.

The position sensor 249 detects a position of the first carriage. The reference white plate 239 is used to conduct a shading correction for scanned image data because the scanned image data may not be correctly converted from a document due to several reasons such as light intensity variation of each light source of the illumination unit 232, light intensity variation in main scanning direction, sensitivity variation of pixels in the CCD 207, for example.

A base unit 248 of the ADF 13 is pivotably connected to a base unit (not shown) of the scanner 10 at one end of the base unit 248.

A handle 250m provided on the base unit 248 is used to lift up the base unit 248 of the ADF 13 from the base unit of the scanner 10. The base unit 248 of the ADF 13 includes a switch to detect opening and closing of the ADF 13.

The ADF 13 includes a press plate 250p, which faces the contact glass 231. When the ADF 13 is closed, the press plate 250p closely contacts the surface of the contact glass 231 as shown in FIG. 2.

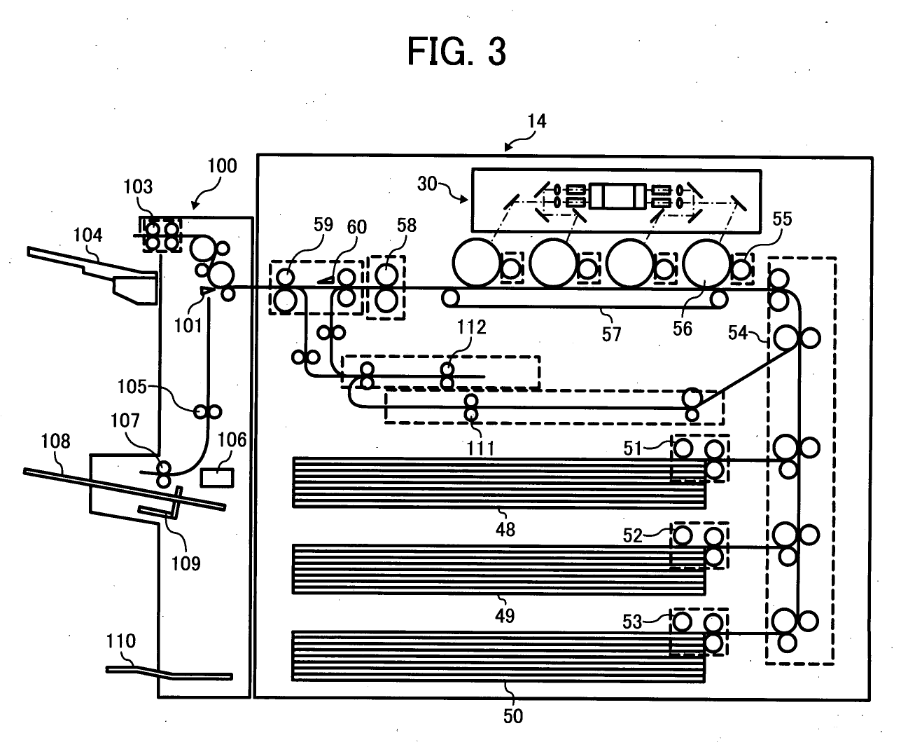

FIG. 3 shows a schematic configuration (according to an example embodiment of the present invention) of the printer 14. The printer 14 includes a laser printer, for example.

The printer 14 includes a photoconductive member 56, a developing unit 55, a charger (not shown), a cleaning unit (not shown), and a transport belt 57, for example.

The photoconductive member 56, developing unit 55, and the charger are used to form a toner image on the photoconductive member 56. The toner image is then transferred to a transfer sheet transported on the transport belt 57.

As shown in FIG. 3, four sets of the photoconductive member 56, developing unit 55, and charger are provided to form four color images of magenta (M), cyan (C), yellow (Y), and black (Bk) on the transfer sheet, wherein such four sets are arranged in a tandem manner along the transport belt 57 to transfer toner images for each color sequentially.

Transfer sheets can be fed from a first tray 48, second tray 49, and third tray 50 by a first sheet feed unit 51, second sheet feed unit 52, and third sheet feed unit 53, respectively. Then, the transfer sheets can be transported to the photoconductive member 56 by a vertical transport unit 54.

Image data scanned by the scanner 10 is corrected by an image data processor IPP (see FIG. 4), and stored in a memory MEM (see FIG. 4) at once, and then read by a writing unit 30 shown in FIG. 3.

The writing unit 30 generates a light beam based on the image data and irradiates the light beam to the photoconductive member 56, uniformly charged by the charger, to write an electrostatic latent image on the photoconductive member 56.

The electrostatic latent image on the photoconductive member 56 is developed by the developing unit 55 as toner image. Then, the toner image is transferred to a transfer sheet from the photoconductive member 56, wherein the transfer sheet is transported by the transport belt 57.

The toner image is fixed on the transfer sheet by a fixing unit 58, and is ejected to the finisher 100 by an ejection roller 59.

The finisher 100 shown in FIG. 3 can guide the transfer sheet to a normal ejection section or a staple processing section.

Specifically, by switching a switch plate 101 to an upward direction, the transfer sheet can be ejected to a normal ejection tray 104 by a transport roller 103.

On one hand, by switching the switch plate 101 to a downward direction, the transfer sheet can be ejected to a staple tray 108 by transport rollers 105 and 107.

Transfer sheets on the staple tray 108 can be collated by a jogger 109 when the transfer sheets are ejected to the staple tray 108. When one printing job is completed, the transfer sheets on the staple tray 108 can be stapled by a stapler 106. The stapled transfer sheets can be stored in an ejection tray 110 shown in FIG. 3.

The normal ejection tray 104 is movable in a lateral direction of the image forming apparatus MF1. The normal ejection tray 104 can be moved in the lateral direction of the image forming apparatus MF1 so that ejected transfer sheets can be sorted with a certain manner such as each document sheet is sorted in a zigzag manner on the normal ejection tray 104.

When images are formed on both face of a transfer sheet, a transfer sheet is not guided to the normal ejection tray 104 but guided to an inverting unit 112 by switching a pawl 60 to a downward direction, and such transfer sheet is stocked in an inverted-sheet feed unit 111 at once.

The transfer sheet stocked in the inverted sheet feed unit 111 is then fed to the photoconductive member 56 to transfer toner images on the transfer sheet. Then, transfer sheet is guided to the normal ejection tray 104 by switching the pawl 60 to a horizontal direction.

As above-described, the inverting unit 112 and the inverted-sheet feed unit 111 are used to form images on both faces of a transfer sheet.

Each of the photoconductive member 56, transport belt 57, fixing unit 58, ejection roller 59, and developing unit 55 can be driven by a main motor (not shown). Each of the sheet feed units 51 to 53 can be driven by the main motor by transmitting a driving force of the main motor with a clutch (not shown). The vertical transport unit 54 can be driven by the main motor by transmitting a driving force of the main motor with an intermediate clutch (not shown).

FIG. 4 shows a schematic internal configuration (according to an example embodiment of the present invention) of the image forming apparatus MF1, used for processing image data.

The image forming apparatus MF1 includes the scanner 10, the printer 14, and the image processing unit ACP.

As shown in FIG. 4, the scanner 10 includes a scan unit 11 and an output I/F (interface) 12 for image data transmission. The output I/F 12 is connected to an image data interface controller CDIC of the image processing unit ACP, wherein the image processing unit ACP controls an access to stored image data, for example. The image data interface controller CDIC is referred as CDIC, hereinafter.

As shown in FIG. 4, the printer 14 is connected to the image processing unit ACP. The printer 14 includes a writing I/F (interface) 15, an image forming unit 16, a process controller 17, a RAM (random access memory) 18, and a non-volatile memory 19, for example.

The writing I/F 15 receives image data from an image data processing processor IPP (hereinafter IPP) of the image processing unit ACP, and the image forming unit 16 conducts a printing operation.

As shown in FIG. 4, the image processing unit ACP (hereinafter, ACP) includes a parallel bus Pb, an image memory access controller IMAC (hereinafter, IMAC), a memory module MEM (hereinafter, MEM) (e.g., volatile and/or non-volatile semiconductor memory) for storing image data, a hard disk unit HDD (hereinafter, HDD) (e.g., magnetic and/or optical) having one or more hard (magnetic and/or optical) disks for storing program and image data, a system controller 1, a RAM 8 (random access memory) 4, a non-volatile memory 5, a font ROM 6, the CDIC, and the IPP, for example. Currently, a hard disk unit provides bulk storage that achieves a good balance of random access (to the stored information) versus cost versus physical size. Other memory technologies can be included in the HDD or used in replacement of the hard disk unit therein. For example, as technology progresses, volatile and/or non-volatile semiconductor memory might supplement or replace the hard disk unit.

As shown in FIG. 4, the facsimile control unit FCU (hereinafter, FCU) is connected to the parallel bus Pb. As shown in FIG. 4, the operation panel 20 is connected to the system controller 1.

The scan unit 11 of the scanner 10 optically scans a document sheet with a light beam. The reflected light from the document sheet is converted into RGB (red, green, and blue) image signals by a CCD (charge coupled device) on a sensor board unit SBU (hereinafter, SBU). The RGB image signals are converted into digital data by an A/D (analog/digital) converter (not shown), and receive a shading correction process. Then the digital data are output to the CDIC through the output I/F 12.

The CDIC controls image data transmission among the output I/F 12 of the scanner 10, parallel bus Pb, and IPP, and controls communications between the process controller 17 and the system controller 1 of the ACP, wherein the system controller 1 controls the ACP as a whole.

In the printing unit 14, the RAM 18 is used as working area for a process controller 17, and the non-volatile memory 19 stores programs including a control program for the process controller 17.

The image memory access controller IMAC (hereinafter, IMAC) controls writing/reading of image data to the MEM and HDD, which store image data.

The system controller 1 controls data reading/writing to the HDD such as program data and control data, which is not directly related to image data, and controls each unit connected to the parallel bus Pb.

The RAM 4 is used as working area for the system controller 1, and the non-volatile memory 5 stores programs including a control program for the system controller 1.

The operation panel 20 is used to instruct a process to be executed by the ACP. For example, such process includes a plurality of processes (e.g., copying, facsimile transmission, scanning, and printing) and a number of sheets to be printed. Accordingly, a user can input information for image data processing with the operation panel 20.

In the scanner 10, image data is scanned by the scan unit 11, and the image data receives a shading correction at the SBU. Then, the image data receives image processing at the IPP such as gamma correction and filtering process to correct errors in image data, and then stored in the MEM or HDD.

When printing images using image data stored in the MEM or HDD, the image data is converted from RGB signal into YMCK (yellow, magenta, cyan, and black) signal at the IPP, and then the image data receives image quality processing such as printer gamma conversion, gray-scale conversion, dithering process, and error diffusion process.

The image data, which received the image quality processing, is then transmitted to the writing I/F 15 from the IPP.

The writing I/F 15 controls a laser beam, corresponding to the image data, by adjusting pulse width and power modulation. Then, the image data is transmitted to the image forming unit 16, and the image forming unit 16 forms an image on a transfer sheet.

The IMAC, which is controlled by the system controller 1, conducts a plurality of functions such as access control to image data in the MEM and HDD, image data transmission to the personal computer PC1 connected to the LAN, and compression/extension of image data for the MEM or HDD.

Image data, transmitted to the IMAC, receives data compression, and then is stored in the MEM or/and HDD. The image data can be retrieved from the MEM or HDD, as appropriate. Retrieved image data is extended to an original image data, and then transmitted to the CDIC via the IMAC and parallel bus Pb.

Then, the image data is transmitted to the IPP from the CDIC, and the image data receives image quality processing. Such image data is output to the writing I/F 15, and the image forming unit 16 forms an image on a transfer sheet based on such image data.

The image forming apparatus MF1 can process image data as digital data with a parallel bus Pb and a bus control by the CDIC.

For example, a facsimile transmission can be conducted as below. Image data, scanned by the scanner 10, receives an image processing at the IPP, and the image data is transmitted to the FCU (facsimile control unit) via the CDIC and parallel bus Pb. The FCU converts the image data into facsimile data usable in communication line, and transmits the facsimile data to the public line PN.

A facsimile receiving can be conducted as below. Facsimile data is received by the FCU from the public line PN, and the FCU converts the facsimile data into image data, and transmits the image data to the IPP via the parallel bus Pb and CDIC. Then, the image data is transmitted to the writing I/F 15, and the image forming unit 16 forms an image on a transfer sheet.

When a plurality of jobs such as copying, facsimile transmission/receiving, and printing is concurrently conducted in the image forming apparatus MF1, the system controller 1 and process controller 17 controls a job allocation of the scan unit 11, image forming unit 16, and parallel bus Pb.

The process controller 17 controls a flow of image data, and the system controller 1 controls a whole system and an activation of each unit.

Functions to be conducted in the image forming apparatus MF1 can be set from the operation panel 20, wherein the image forming apparatus MF1 can conducts a plurality of functions. Accordingly, a user can set conditions such as copying, and facsimile communication with the operation panel 20.

The system controller 1 and process controller 17 communicate with each other via the parallel bus Pb, CDIC, and serial bus Sb.

Specifically, based on data format conversion by the CDIC between the parallel bus Pb and serial bus Sb, the system controller 1 and the process controller 17 can communicate data with each other.

A plurality of bus interfaces such as parallel bus I/F 7, serial bus I/F 9, local bus I/F 3, and network I/F 8 are connected to the IMAC as shown in FIG. 4. The system controller 1 is connected to a plurality of units via such plurality of buses.

The system controller 1 controls a plurality of units via the parallel bus Pb. The parallel bus Pb is also used to transmit image data.

The system controller 1 commands an operation control signal to the IMAC to store image data in the MEM, for example. By responding to the operation control signal, image data is transmitted from the CDIC to the IMAC via the parallel bus Pb and parallel bus I/F 7. Then, the image data is stored in the MEM under a control of IMAC.

The system controller 1 in the ACP conducts a printer control, network control, and a serial bus control when a printing function is requested from a PC. For example, the IMAC receives printout-requesting signal via the network I/F 8 when such request is made from a PC on the network.

The printout-requesting signal is then transmitted to the MEM under a control of the system controller 1 to retrieve image data.

A font data required for the image data in the MEM is obtained from the font ROM 6 via the local bus I/F 3 and local bus Rb. The local bus Rb connects the system controller 1 to the non-volatile memory 5 and RAM 4.

An external serial port 2 can be used to connect the image forming apparatus MF1 to a PC with a serial bus. The operation panel 20 and ACP can be interfaced with each other with a serial bus. The operation panel 20 communicates with the system controller 1 and the IMAC to input image processing condition and display system condition.

The system controller 1 communicates data with the MEM, HDD, and above-mentioned buses via the IMAC.

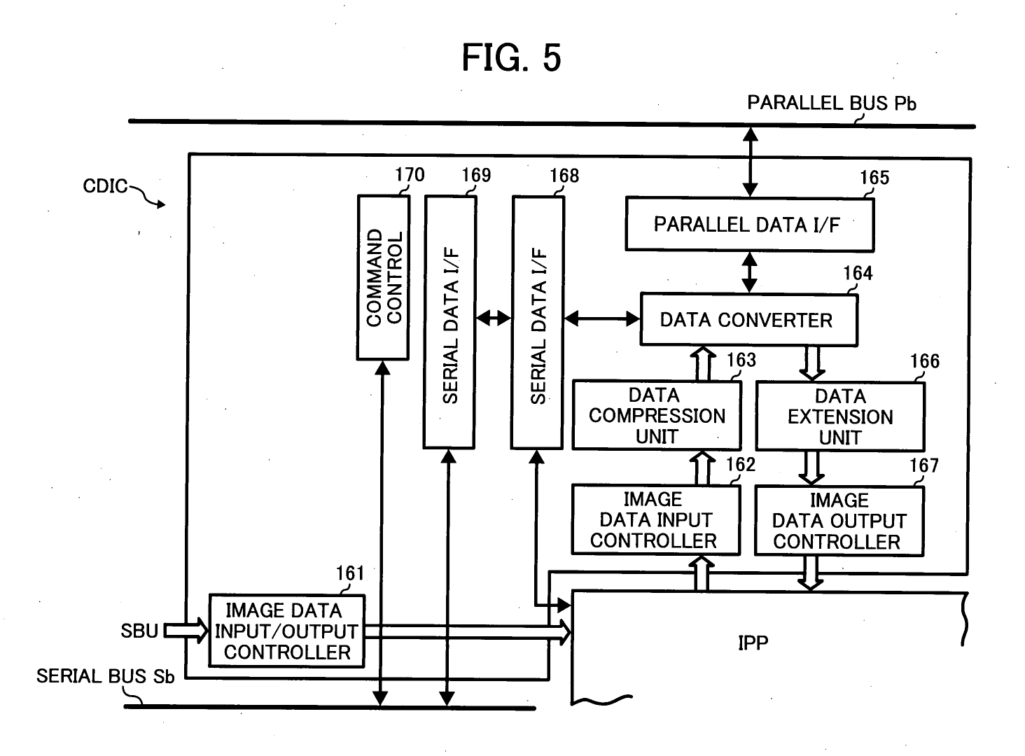

FIG. 5 is a schematic configuration showing in more detail (according to an example embodiment of the present invention) the CDIC. The CDIC includes an image data input/output controller 161, an image data input controller 162, a data compression unit 163, a data converter 164, a parallel data I/F (interface) 165, a data extension unit 166, an image data output controller 167, serial data I/Fs 168 and 169, and a command controller 170.

The image data input/output controller 161 receives image data from the scanner 10, and outputs image data to the IPP.

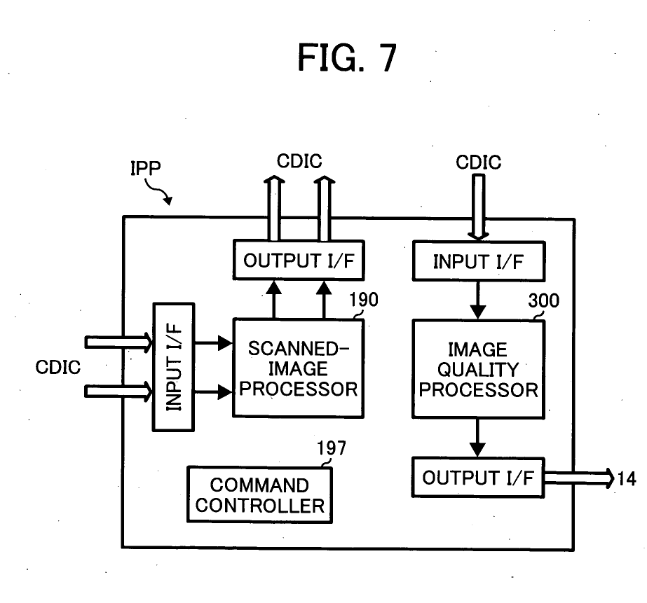

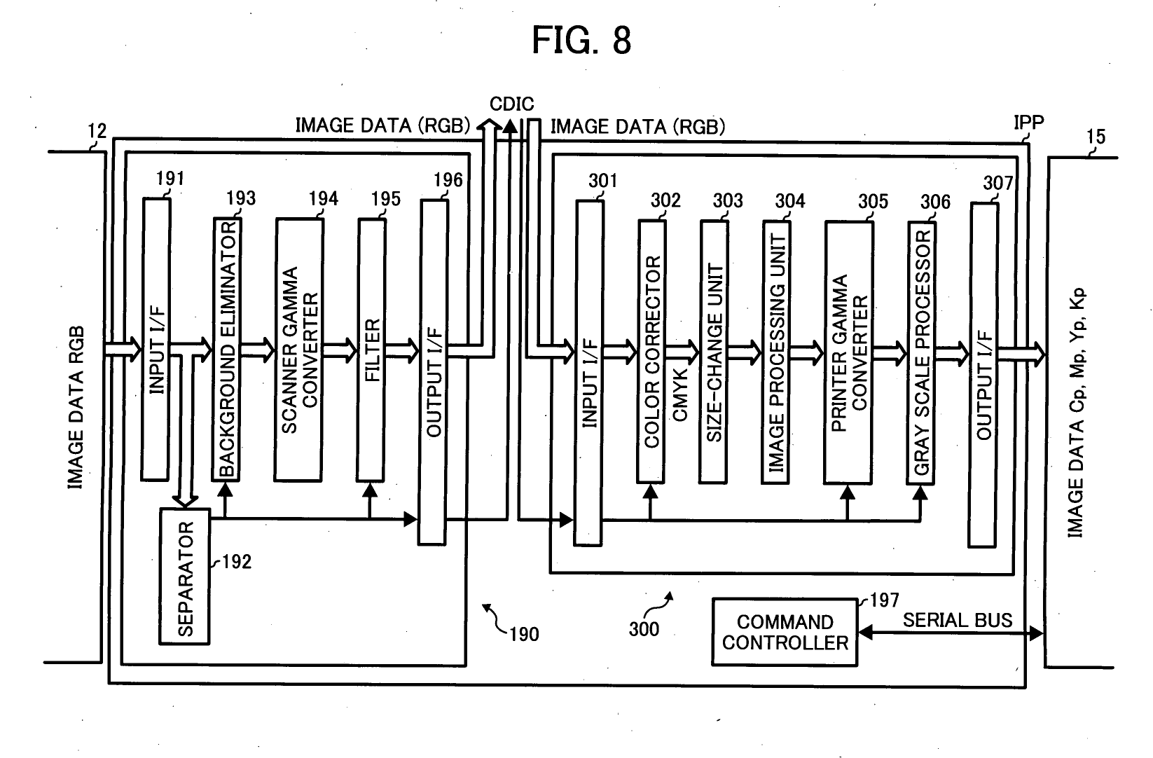

The IPP includes a scanned-image processor 190 (FIGS. 7 and 8) to process scanned image data, and outputs image data to the input system controller 162 of the CDIC.

The image data input controller 162 transmits the image data to the data compression unit 163.

The data compression unit 163 conducts a primary compression for image data so that transmission efficiency of the image data in the parallel bus Pb can be increased.

The data converter 164 receives the compressed image data from the data compression unit 163, converts the compressed image data into parallel data, and transmits the parallel data to the parallel data I/F 165.

Then, the parallel data is transmitted to the parallel bus Pb via the parallel data I/F 165.

On one hand, image data is input to the data converter 164 from the parallel data bus Pb via the parallel data I/F 165, wherein the data is compressed for data transmission in the bus.

The data converter 164 converts the image data into serial data, and the data extension unit 166 extends the compressed image data.

The extended image data is transmitted to the IPP by the image data output controller 167.

In the IPP, an image quality processor 300 (see FIGS. 7 and 8) converts RGB (red, green, blue) image data into YMCK (yellow, magenta, cyan, black) image data, and the image quality processor 300 outputs image data of Yp, Mp, Cp, Kp (yellow, magenta, cyan, black) for printout data, which is usable for the printer 14.

The CDIC is used to convert parallel data transmitted from the parallel bus Pb into serial data, and to convert serial data transmitted from the serial bus Sb into parallel data.

The system controller 1 transmits data to the parallel bus Pb, and the process controller 17 transmits data to the serial bus Sb.

In order to make communication between the system controller 1 and process controller 17, the data converter 164 and serial data I/F 169 conduct parallel-to-serial data conversion.

The serial data I/F 168 is used for data communication with the IPP, and is used for communicating serial data with the IPR

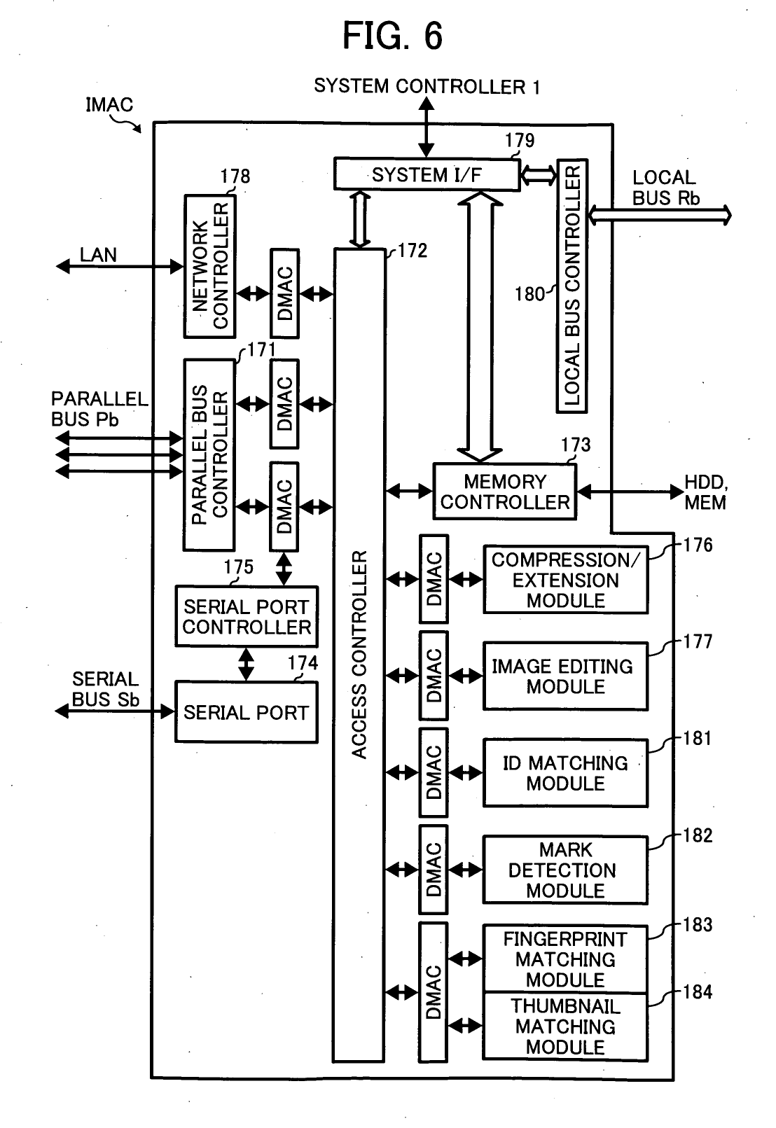

FIG. 6 is a schematic configuration showing in more detail (according to an example embodiment of the present invention) the IMAC (image memory access controller).

As shown in FIG. 6, the IMAC includes a parallel bus controller 171, an access controller 172, a memory controller 173, a serial port 174, a serial port controller 175, a compression/extension module 176, an image editing module 177, a network controller 178, a system I/F 179, and a local bus controller 180.

The IMAC also includes an ID matching module 181, a mark detection module 182, a fingerprint matching module 183, and a thumbnail matching module 184.

The compression/extension module 176, image editing module 177, parallel bus controller 171, serial port controller 175, network controller 178, ID matching module 181, mark detection module 182, fingerprint matching module 183, and thumbnail matching module 184 are connected to the access controller 172 via respective DMACs (direct memory access controller) as shown in FIG. 6.

The system I/F 179 is used for communicating command and data with the system controller 1, which controls the ACP as a whole. The system controller 1 also controls resource allocation of the MEM and HDD. The system controller 1 also controls other units via the system I/F 179, parallel bus controller 171, and parallel bus Pb.

Each unit in the ACP is typically connected to the parallel bus Pb. Accordingly, the parallel bus controller 171 controls data communication between each unit in the ACP and the system controller 1, MEM, and HDD by controlling occupation time of bus used for communication.

The network controller 178 controls a connection of the IMAC to LAN (local area network) or Internet. The network controller 178 controls data communication of an external apparatus connected to a network (e.g., LAN or Internet) and the IMAC.

The network controller 178 controls a file and mail communication via the LAN or Internet and a server set up in the in the HDD such as world wide web server, FTP (file transfer protocol) server, SMTP (simple mail transfer protocol) server, DHCP (dynamic host configuration protocol) server, file server, and mail server.

Furthermore, the network controller 178 generates a transmission file and adds a received file to a directory.

The system controller 1 controls a network interface of the IMAC. For example, the system controller 1 instructs a generation of transmission file, a generation of directory for transmission file, and a transmission of transmission file to the IMAC in response to a command such as command from the operation panel 20 for document scan.

The serial port 174 connected to the serial bus Sb includes a plurality of ports. The serial port controller 175 includes a plurality of port controllers, which can correspond to communication buses prepared for a whole system. The serial port controller 175 controls commanding to the operation panel 20 and data communication for displaying a view on the operation panel 20.

As shown in FIG. 4, the local serial bus Rb is connected to the RAM 4, non-volatile memory 5, and font ROM 6. The local bus controller 180 can function as interface between the system I/F 179 and the local serial bus Rb.

The access controller 172 is connected to the system controller 1 via the system I/F 179, and the system controller 1 instructs a command to the access controller 172. Furthermore, the access controller 172 controls an access to the MEM and HDD from an external apparatus.

Image data can be transmitted from the CDIC to the IMAC via the parallel bus Pb, and then the image data can be received by the parallel bus controller 171 of the IMAC.

The image data received by the parallel bus controller 171 of the IMAC can be accessed to the memory such as MEM and HDD. The received image data can be controlled by the direct memory access controller (DMAC).

As for accessing of the imaged data to the MEM, HDD, the access controller 172 controls access requests requested from a plurality of units by adjusting conditions such as access time.

The memory controller 173 controls an access operation for the MEM or HDD, and data reading/writing for the MEM or HDD, for example.

Data from a network can be transmitted to the MEM and HDD as below. Data received by the network controller 178 of the IMAC from a network is transmitted to the MEM and HDD by the DMAC (direct memory access controller).

The access controller 172 controls access requests to the MEM and HDD when a plurality of jobs are conducted.

The memory controller 173 conducts data reading/writing for the MEM and HDD.

When to access the MEM and HDD from the serial bus Sb, data received by the IMAC via the serial port 174 and serial port controller 175 is transmitted to the MEM or HDD by the DMAC.

A PC (personal computer) connected to a network or serial bus Sb may output data for printing. The system controller 1 controls transmission of data for printing to a memory area of the MEM or HDD by using font data obtained from the local bus.

The system controller 1 controls an interface operation with an external unit.

After the data is received by the IMAC, each DMAC in the IMAC shown in FIG. 6 controls data transmission to the MEM or HDD. Because each DMAC controls data transmission to the MEM or HDD independently, the access controller 172 controls an access operation to the MEM and HDD, and assigns priorities for each access request made by each DMAC to the MEM or HDD.

In addition to access to the MEM and HDD by each DMAC shown in FIG. 6, the system controller 1 can access to the MEM and HDD via the system I/F 179.

When the access controller 172 allows an access of data to the MEM and HDD, data can be transmitted to the MEM or HDD via the memory controller 173. Similarly, data from the system I/F 179 is transmitted to the MEM or HDD via the memory controller 173.

The IMAC includes the compression/extension module 176 and image editing module 177 for data processing.

The compression/extension module 176 may include MH (modified huffman) encoding/decoding function, JPEG (joint photographic experts group) encoding/decoding function, TIFF (tagged image file format) filing function, and PDF (portable document format) filing function, for example.

The MH encoding/decoding function is used for compression and extension of binary image data. The JPEG encoding/decoding function is used for compression and extension of multi-value image data.

The compression/extension module 176 conducts data compression for efficient storing of image data or code data in the MEM or HDD, data filing, and extension of compressed data, for example.

When storing image data in the HDD or MEM, the compression/extension module 176 converts image data into a desired data format and file format.

Furthermore, when reading and then transmitting image data from the HDD or MEM to a network, the compression/extension module 176 can convert image data into a desired data format and file format.

Image data stored in the MEM or HDD is transmitted to the compression/extension module 176 via the memory controller 173, access controller 172, and the DMAC connected to the access controller 172.

The image data converted by the compression/extension module 176 can be returned to the MEM or HDD, or output to a bus by the DMAC.

The image editing module 177 controls the MEM and HDD with the DMAC, and conducts data processing in the MEM or HDD. Specifically, the image editing module 177 conducts clearing of memory area and data processing such as image data rotation, and combination of different images, for example.

Secondary compressed data read from the MEM or HDD, is extended to primary compressed data by the compression/extension module 176.

In the image editing module 177, the primary compressed data is extended to image data with a decoding logic similar to the data extension unit 166 of the CDIC.

The image editing module 177 stores such image data in memory area of the image editing module 177, and processes the image data.

Then, the processed image data is primary compressed with an encoding logic similar to primary compression logic of the CDIC, and is secondary compressed with the compression/extension module 176. Such secondary compressed image data can be written in the MEM or HDD.

The ID matching module 181 checks an ID (identification) information, which is input to the image forming apparatus MF1 as below. The ID information includes a user ID, wherein the user ID includes a user name, user number or the like, for example.

When the ID information is input from the operation panel 20, the ID information is transmitted to the ID matching module 181 via the system controller 1.

The DMAC connected to the ID matching module 181 reads registered IDs in an ID-registered area of the HDD, and searches an ID from the registered IDs, which can match the input ID information.

If an ID, which can match the input ID information, is found in the ID-registered area of the HDD, the ID matching module 181 transmits “ID-verified” information to the system controller 1.

If an ID, which can match the input ID information, is not found in the ID-registered area of the HDD, the ID matching module 181 transmits “ID-not-verified” information to the system controller 1.

The ID information can be registered to the image forming apparatus MF1 with a register unit provided to the system controller 1, for example.

The mark detection module 182 detects a mark included on a document image, wherein the mark includes a security mark for the document, for example.

The DMAC connected to the mark detection module 182 extracts image data stored in the MEM, wherein the image data is obtained by scanning one or more documents by the scanner. The DMAC reads image data in a reference area of the extracted image data, wherein such area includes security mark area.

Then, the DMAC connected to the mark detection module 182 reads image data stored in the HDD, and searches a reference area of the image data, wherein such area includes security mark registered area.

If the mark detection module 182 compares and confirms that the above-mentioned two image data are identical with each other, the mark detection module 182 transmits “security mark confirmed” information to the system controller 1.

If the mark detection module 182 compares and confirms that the above-mentioned two image data are not identical with each other, the mark detection module 182 transmits “security mark not-confirmed” information to the system controller 1.

The mark can be registered to the image forming apparatus MF1 with a register unit provided to the system controller 1, for example.

The fingerprint matching module 183 receives a fingerprint verification command from the system controller 1. Specifically, the operation panel 20 includes an LCD (liquid crystal display) touch panel 21 having pixel matrix used for inputting fingerprint. When a fingerprint is input to the pixel matrix by touching the LCD touch panel 21 with a fingertip, the DMAC of the fingerprint matching module 183 reads information of each pixel on the operation panel 20.

The DMAC connected to the fingerprint matching module 183 reads registered fingerprints in an fingerprint registered area of the HDD, and searches a registered fingerprint which can match an input fingerprint.

If a registered fingerprint in the fingerprint-registered area of the HDD matches the input fingerprint, the fingerprint matching module 183 transmits “fingerprint-verified” information to the system controller 1.

If the registered fingerprints in the fingerprint-registered area of the HDD do not match the input fingerprint, the fingerprint matching module 183 transmits “fingerprint not-verified” information to the system controller 1.

The fingerprint can be registered to the image forming apparatus MF1 with a register unit provided to the system controller 1, for example.

The thumbnail matching module 184 generates a thumbnail view for image data stored in the MEM with the DMAC connected to the thumbnail matching module 184. Such image data can be stored in the MEM by scanning a document with the scanner 10, for example. The thumbnail view is a size-reduced view of image data, for example.

The DMAC connected to the thumbnail matching module 184 reads image data stored in a folder of the HDD, wherein the folder can be assigned to one user with a user ID by the system controller 1.

The thumbnail matching module 184 generates a thumbnail view by reading the image data in the HDD, and searches whether the generated thumbnail view matches a thumbnail view generated from the scanned image data.

If such two thumbnail matches, the thumbnail matching module 184 transmits “image confirmed” information to the system controller 1, wherein the “image confirmed” means that same image is found.

If such two thumbnails do not match with each other, the thumbnail matching module 184 transmits “image not-confirmed” information to the system controller 1, wherein the “image not-confirmed” means that same image is not found.

FIG. 7 is a schematic configuration showing in more detail (according to an example embodiment of the present invention) the IPP, which is used for image processing.

As shown in FIG. 7, the IPP includes a scanned-image processor 190, a printer image quality processor 300, and a command controller 197.

Image data scanned by the scanner 10 is transmitted to an input I/F (interface) of the scanned-image processor 190 of the IPP via the SBU and CDIC.

The scanned-image processor 190 is used for conducting image data correction such as shading correction and scanner gamma conversion, for example. After correcting the image data, the image data is transmitted from the scanned-image processor 190 to the CDIC, and stored in the MEM or HDD.

The image data stored in the MEM or HDD is then read and transmitted to the IPP via the CDIC.

FIG. 8 shows a schematic configuration showing in more detail (according to an example embodiment of the present invention) the scanned-image processor 190 and image quality processor 300 for explaining image processing in the IPP in detail.

The scanned-image processor 190 includes an input I/F 191, a separator 192, a background eliminator 193, a scanner gamma converter 194, a filter 195, and an output I/F 196 as shown in FIG. 8. The separator 192 judges whether an image includes a character area and photo area.

The image quality processor 300 includes an input I/F 301, a color corrector 302, a size-change unit 303, an image processing unit 304, a printer gamma converter 305, a grayscale processor 306, and an output I/F 307 as shown in FIG. 8.

The IPP is a programmable processor for conducting an image processing. Image data scanned by the scanner 10 is transmitted to the CDIC via the output I/F 12 of the scanner 10, and then transmitted to the scanned-image processor 190 of the IPP.

The scanned-image processor 190 corrects image data, which may be deteriorated in a course of quantizing optical data to digital data, and transmits the corrected image data to the CDIC.

Then, the CDIC returns the image data to the image quality processor 300 of the IPP. In the image quality processor 300, the color corrector 302 converts RGB signal to YMCK signal. The size-change unit 303 conducts magnification of image data, the image processing unit 304 conducts image processing, the printer gamma converter 305 conducts gamma correction, and the grayscale processor 306 conducts gray-scale conversion, dither processing, or error diffusion processing.

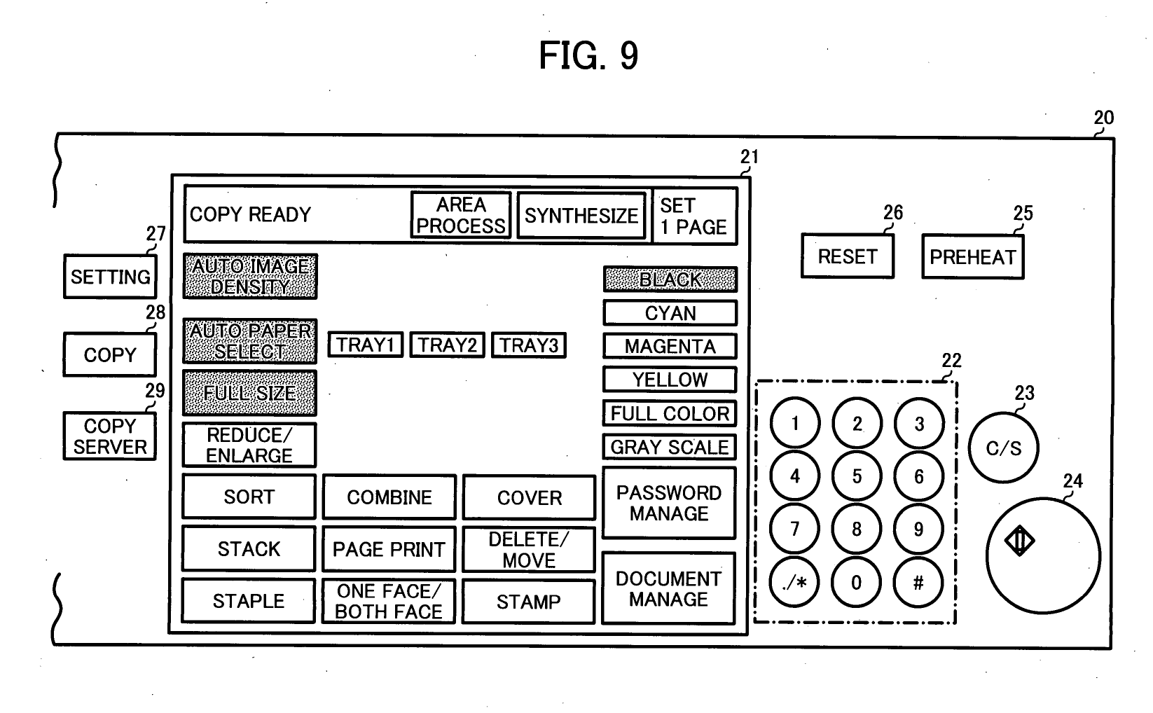

FIG. 9 shows a schematic view (according to an example embodiment of the present invention) the operation panel 20. The operation panel 20 includes the LCD touch panel 21, a numeric key 22, a clear/stop (C/S) key 23, a start key 24, a preheat key 25, a reset key 26, a setting key 27, a copy key 28, and a copy server key 29.

The LCD touch panel 21 can display function keys, number of copies, and status message of the image forming apparatus MF1, for example, as shown in FIG. 9.

The setting key 27 can be used for customizing an initial status of the image forming apparatus MF1. For example, a sheet size usable in the image forming apparatus MF1, and status information when the clear key 23 is pressed can be set with the setting key 27.

Furthermore, the setting key 27 can be used for automatically selecting a mode when no-operation condition continues for a certain time, and for setting timing for shifting an apparatus condition to an energy saving mode, and for setting a timing for shifting an apparatus condition to auto-off/sleep mode, for example.

The preheat key 25 is pressed to shift an apparatus condition from stand-by mode to energy saving mode (i.e., preheat status) to reduce a fixing temperature and to light off a display of the operation panel 20. The preheat status includes an energy saving status, which can be defined by the International Energy Star Program, for example. The preheat key 25 is pressed again to shift an apparatus condition from preheat status and off-status/sleep mode to the stand-by mode.

The copy key 28 is pressed when to conduct copy function.

The copy server key 29 is used to register a user ID and fingerprint to a server, to scan one or more documents and store the corresponding image data, and to edit stored image data with copy mode, printing mode, and deletion mode, for example.

FIG. 9 shows the LCD touch panel 21, which displays a default screen view for copy mode.

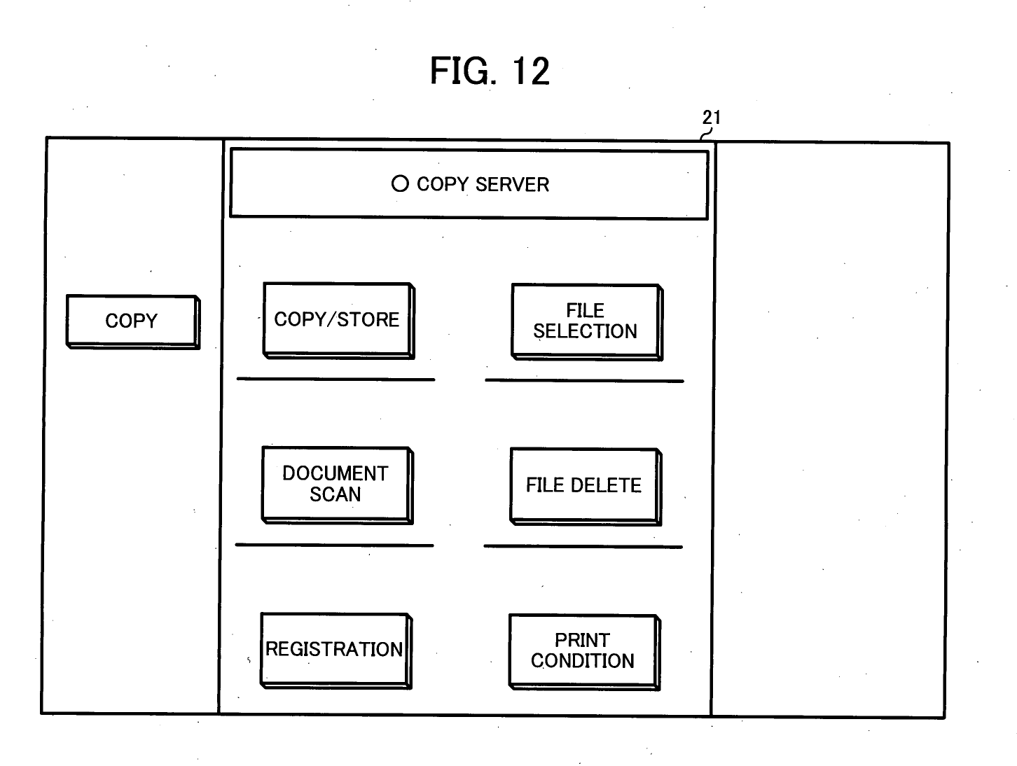

When a user touches the copy server key 29, the LCD touch panel 21 switches the default screen view to a copy server view shown in FIG. 12 to be described later.

When a user touches a copy key on the copy server view shown in FIG. 12, the LCD touch panel 21 switches a screen view to the default screen shown in FIG. 9. The copy server view shown in FIG. 12 will be described later in detail.

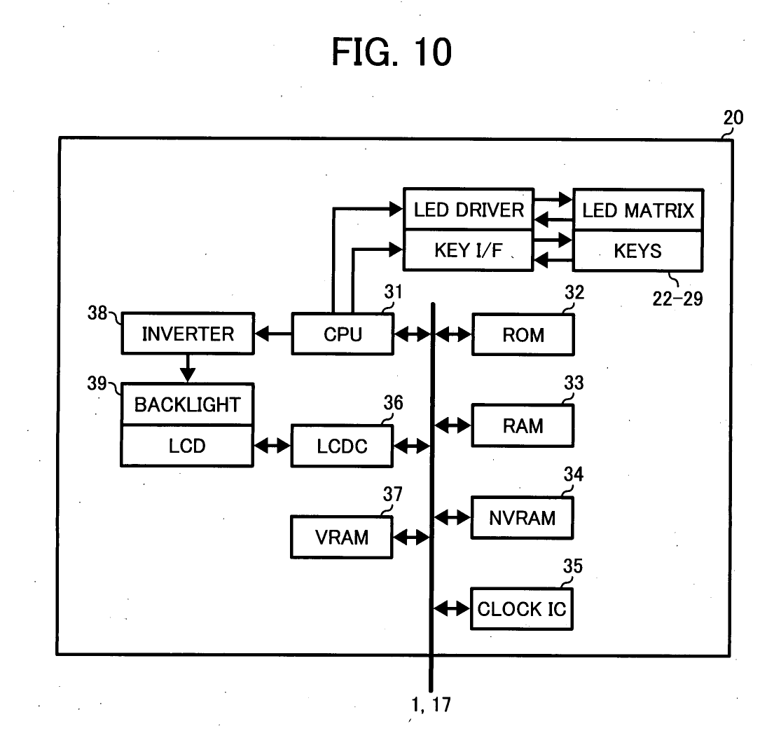

FIG. 10 is a block diagram (according to an example embodiment of the present invention) for the operation panel 20. As shown in FIG. 10, the circuit block of the operation panel 20 includes a CPU (central processing unit) 31, a ROM (read only memory) 32, a RAM (random access memory) 33, a non-volatile RAM (NVRAM) 34, a clock IC (integrated circuit) 35, a liquid crystal display controller (LCDC) 36, a VRAM (volatile random access memory) 37, and an inverter 38, for example.

The CPU 31 communicates with the system controller 1 of the ACP and the access controller 172 of the IMAC, reads information input by the operation panel 20, and controls conditions shown on the operation panel 20.

The ROM 32 stores control programs used by the CPU 31. The RAM 33 temporarily stores data related to controlling condition. The clock IC 35 generates time signal.

The VRAM 37 stores a plurality of screen views to be displayed on the LCD touch panel 21.

The LCDC 36 is connected to the VRAM 37, and controls timing for displaying screen views on the LCD touch panel 21 and senses a touching on the operation panel 20. The LCDC 36 is also connected to a LCD of the LCD touch panel 21 having a backlight 39 such as CFL (compact fluorescent lamp) as light source.

The CPU 31 is further connected to the inverter 38, which drives the backlight 39, the keys 22 to 29, and a LED driver, which drives an LED matrix of the operation panel 20. Furthermore, the CPU 31 is connected to the NVRAM 34 via a data bus, wherein the NVRAM 34 can store image processing modes.

The CPU 31 of the operation panel 20 conducts reading of input information and controlling of output to the LCD touch panel 40 based on a user operation to the operation panel 20.

For example, the CPU 31 reads pressed key information and input numeric data, transmits fingerprint information touched on a fingerprint input area (pixel matrix area) to the IMAC, reads a pushing of start key 24, transmits a start command to the system controller 1, and reads a sheet size switching information.

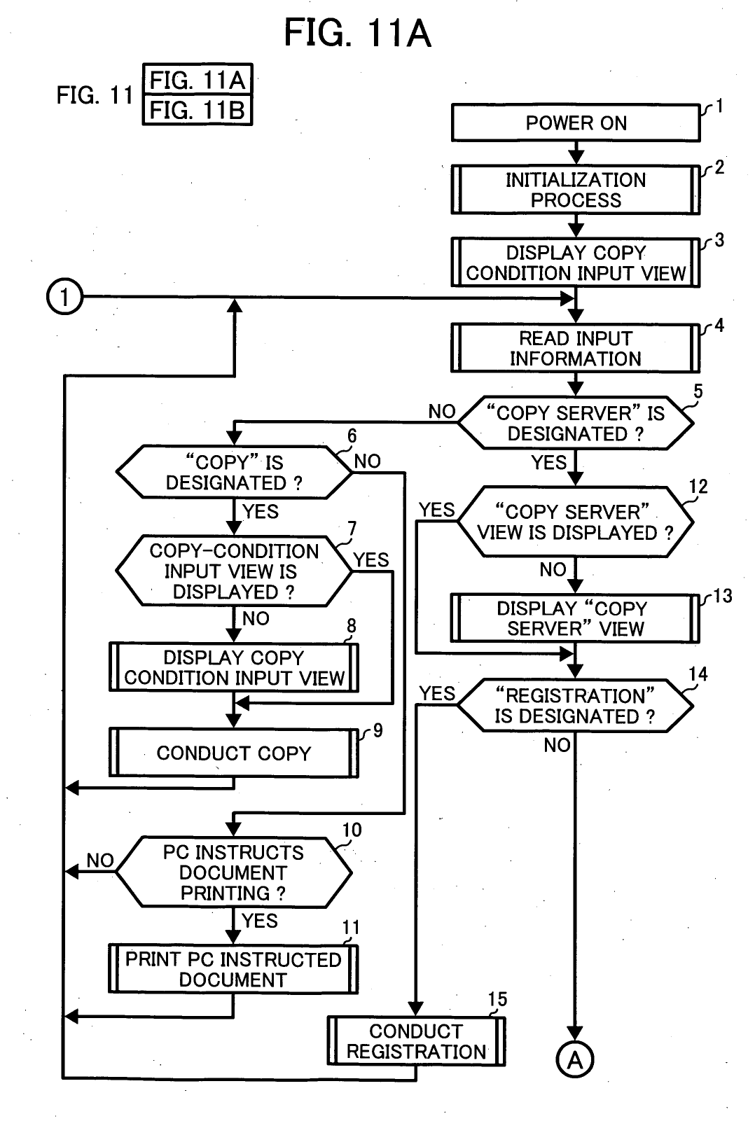

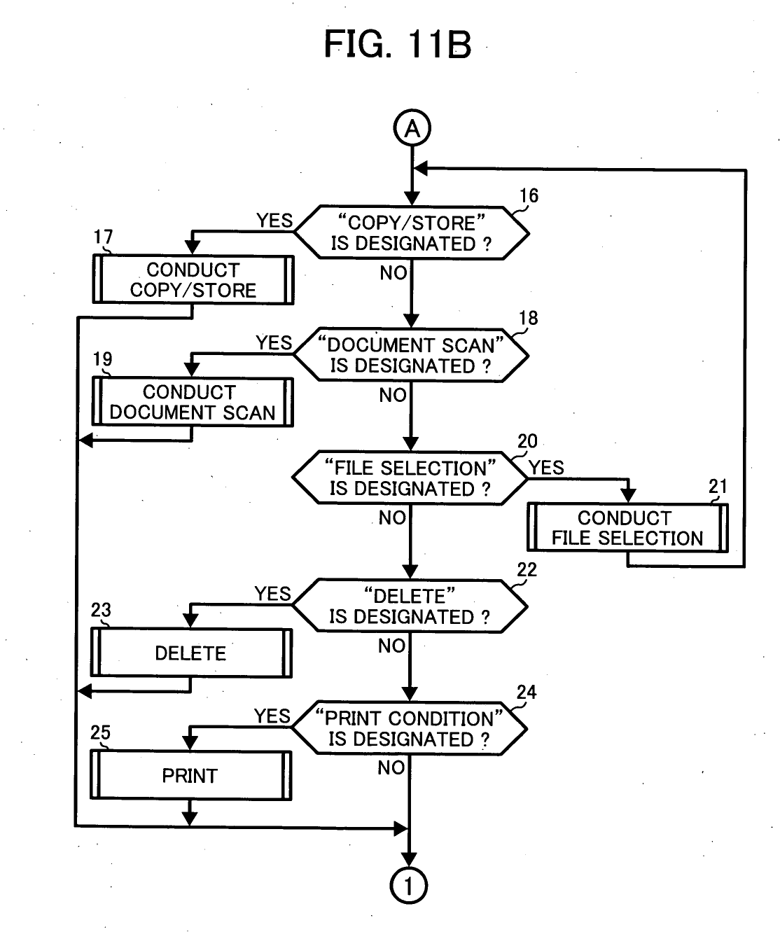

FIGS. 11A and 11B (or, collectively, FIG. 11) show a flow chart (according to an example embodiment of the present invention) for explaining an image process control by the system controller 1 shown in FIG. 4.

At step 1, the image forming apparatus MF1 is supplied with a power. For example, a power source circuit (not shown) supplies power to the image forming apparatus MF1.

At step 2, the system controller 1 conducts an initialization process in response to power ON at step 1.

At step 3, the LCD touch panel 21 of the operation panel 20 displays a default screen view shown in FIG. 9 as a copy-condition input view under a control of the CPU 31 of the operation panel 20.

The system controller 1 conducts reading of input information to the operation panel 20 and switching of a screen view on the operation panel 20 by communicating with the CPU 31 in the operation panel 20.

At step 4, the CPU 31 of the operation panel 20 reads information input to the operation panel 20. For example, such information includes user-input information to the operation panel 20, and information from the PC 1 to PC 3 via a network and other external apparatuses.

At step 5, the CPU 31 judges whether a user designates a “copy server” key on the operation panel 20.

If the CPU 31 judges that the “copy server” key is not designated at step 5, the CPU 31 judges whether the user designates a “copy” key on the operation panel 20 at step 6.

If the CPU 31 judges that the “copy” key is designated on the operation panel 20 at step 6, the CPU 31 judges whether a copy-condition input view is displayed on the operation panel 20 at step 7.

If the CPU 31 judges that the copy-condition input view is not displayed on the operation panel 20, the CPU 31 displays the copy-condition input view on the operation panel 20 at step 8.

At step 9, the image forming apparatus MF1 can conduct a copying process by pushing of the start key 24.

In such copying process, image data scanned by the scanner 10 is stored temporarily in the MEM or HDD when conducting a copying of designated number of sheets. Such image data can be, e.g., automatically erased from the MEM or HDD when the copying of designated number of sheets completes.

If the CPU 31 judges that the “copy” key is not designated on the operation panel 20 at step 6, the CPU 31 judges whether an external apparatus such as PC (personal computer) instructs a printing to the image forming apparatus MF1 at step 10.

If the CPU 31 judges that the external apparatus such as PC instructs a printing to the image forming apparatus MF1, the image forming apparatus MF1 conducts a printing of document transmitted from the external apparatus such as PC, for example.

In such printing process, document image data transmitted from the external apparatus (e.g., PC) is stored temporarily in the MEM or HDD when conducting a printing of designated number of sheets. Such document image data can be, e.g., automatically erased from the MEM or HDD when the printing of designated number of sheets completes.

If the CPU 31 judges that the “copy server” is designated by the copy server key 29 at step 5, the CPU 31 judges whether a “copy server” view is displayed on the operation panel 20 at step 12.

If the CPU 31 judges that the “copy server” view is not displayed on the operation panel 20 at step 12, the CPU 31 displays the “copy server” view on the operation panel 20 at step 13.

The “copy server” view on the LCD touch panel 21 of the operation panel 20 is shown (according to an example embodiment of the present invention) in FIG. 12 as one example.

For example, the “copy server” view includes a copy/store key, a document scan key, a registration key, a file selection key, a file delete key, and a print condition key as shown in FIG. 12.

The copy/store key is used to scan one or more documents and generate corresponding image data with the scanner 10, to store scanned image data in the HDD and to print the image data with the printer 14.

The document scan key is used to scan one or more documents and generate corresponding image data with the scanner 10, and store scanned image data in the HDD.

The registration key is used to register a user ID and fingerprint of user into the image forming apparatus MF1.

The file selection key is used to designate a file from a file list stored in the HDD, and to display the designated file on the LCD touch panel 21. The designated file can include image data. Such image data can represent at least a subset of image data stored in the HDD.

The file delete key is used to delete a file from the file list stored in the HDD.

The print condition key is used to display a view for inputting print conditions.

When the start key 24 is pressed while displaying a view for inputting print conditions, the image forming apparatus MF1 starts a printing with print conditions displayed on the view.

The copy key provided to a left side of the LCD touch panel 21 is used to return a screen view to the default screen view shown in FIG. 9 from the “copy server” view.

If the user touches the registration key at step 14, the CPU 31 displays a “registration” input view on the LCD touch panel 21 of the operation panel 20 at step 15.

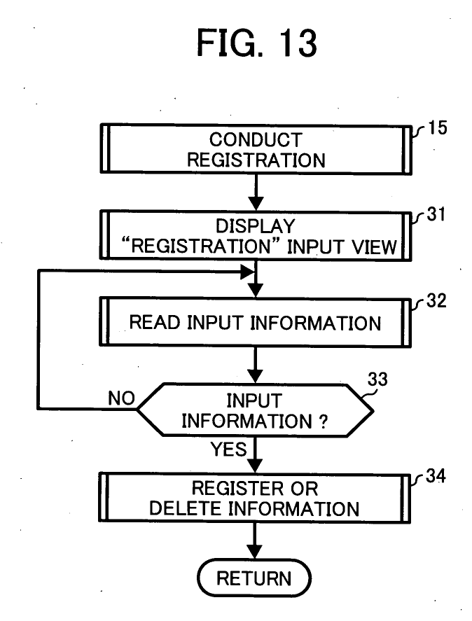

FIG. 13 shows a flow chart for explaining (according to an example embodiment of the present invention) “registration” process conducted at step 15. The “registration” process includes steps 31 to 34 as shown in FIG. 13.

At step 31 in FIG. 13, the “registration” input view is displayed on the LCD touch panel 21.

Although not shown, the “registration” input view can include one or more of a user ID input area, a fingerprint input area to be touched by a fingertip, an automatically generated name for the user's folder (wherein the automatically generated name can be changed), and instruction keys such as registration, deletion, and cancel key.

When the user attempts to change a folder name. the user can be required to input identification, e.g., input a user ID, place a fingertip on the fingerprint input area, and/or touch a registration key. This can be done in a manner corresponding to steps 31 to 33, and then such input information is transmitted from the operation panel 20 to the IMAC via the system controller 1.

Then, the memory controller 173 of the IMAC automatically generates a user folder in the HDD for the input user ID, and registers the user ID in an ID-registered area in the HDD, and registers the fingerprint in the fingerprint registered area in the HDD, respectively, at step 34.

On one hand, when the user inputs a user ID, places a fingertip on the fingerprint input area, and/or touches a deletion key at steps 31 to 33, the memory controller 173 of the IMAC can, e.g., erase the user folder provided for the input user ID from the HDD, and can, e.g., delete the user ID and/or fingerprint from the HDD at step 34.

FIG. 11 is referred again for step 16 and subsequent steps.

If the user does not touch the registration key at step 14, the CPU 31 judges whether the user designates “copy/store” key on the LCD touch panel 21 of the operation panel 20 at step 16.

If the user touches the copy/store key on the “copy server” view at step 16, the CPU 31 displays “copy/store” input view (not shown) on the LCD touch panel 21 of the operation panel 20 at step 17.

The “copy/store” input view includes a user ID input section and and/or fingerprint input section for user verification, which are added to copy-condition input view of the LCD touch panel 21 shown in FIG. 9.

At step 17, one or more documents are scanned and corresponding image data is generated and stored in the image forming apparatus MF1, and the scanned image data is printed by the printer 14. Then, printed information, which indicates that image data has been printed at least one time, is assigned to the image data stored in the image forming apparatus MF1.

If the user does not touch the “copy/store” key at step 16, the CPU 31 judges whether the user designates the document scan key on the LCD touch panel 21 of the operation panel 20 at step 18.

If the user touches the document scan key on the “copy server” view (FIG. 12) at step 18, the CPU 31 conducts document scanning at step 19.

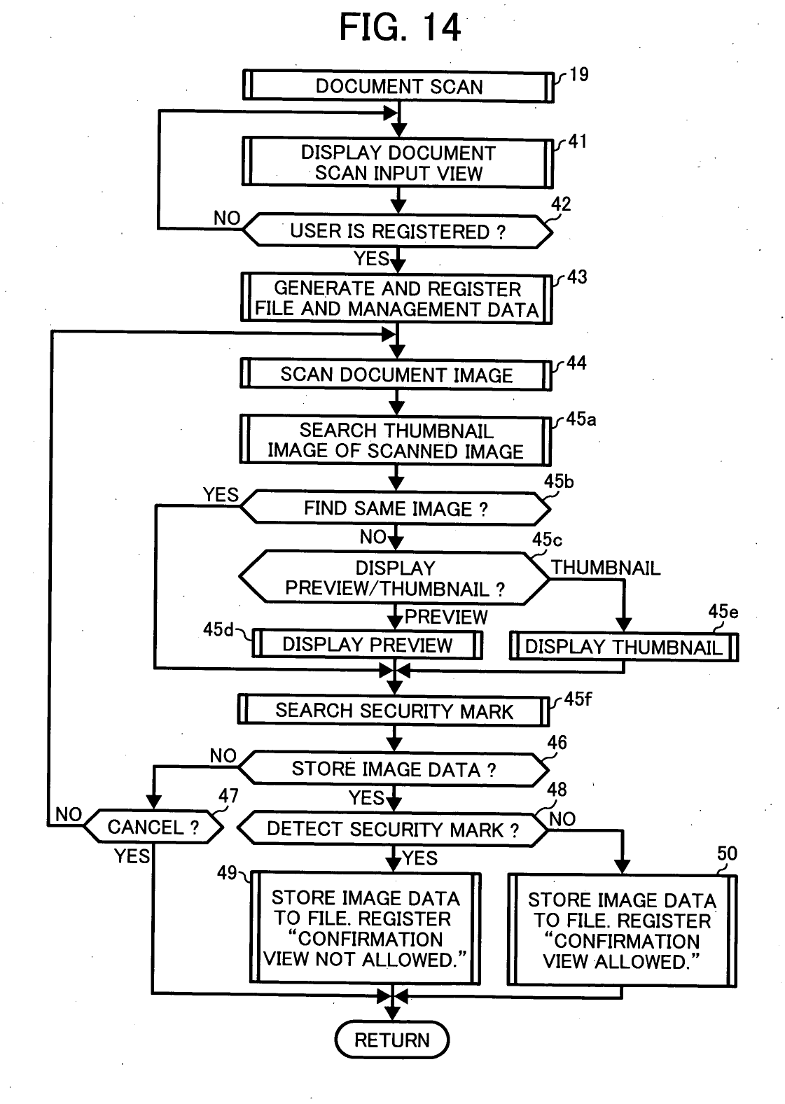

FIG. 14 is a flow chart for explaining (according to an example embodiment of the present invention) a process of document scanning at step 19 in detail. The document scanning includes steps 41 to 50 as shown in FIG. 14.

At step 41, the CPU 31 displays a document scan input view (not shown) on the LCD touch panel 21.

The document scan input view (not shown) includes a user ID input section and and/or fingerprint input section for user verification, which are added to copy-condition input view of the LCD touch panel 21 shown in FIG. 9 while omitting keys for printing.

At step 42, the CPU 31 judges whether use ID is registered in the image forming apparatus MF1.

When a user inputs a registered ID and/or registered fingerprint from the LCD touch panel 21, the system controller 1 generates a file in a user folder, corresponding to the input ID, in the HDD with the memory controller 173 of the IMAC.

The LCD touch panel 21 displays the generated file name, which is changeable, and keys for selecting security management/non-security management and for selecting preview/thumbnail. For example, the security management and thumbnail may be set as default condition.

When a user touches the store key after selecting conditions, the system controller 1 registers a selection result of security management/non-management and preview/thumbnail to the generated file with other management data such as year/month/date information at step 43.

When the start key 24 is pressed, the system controller 1 starts document scanning, reads image data scanned by the scanner 10 with the IMAC, and writes the image data to the MEM at step 44.

Then, the system controller 1 instructs the IMAC to search a same image for the scanned image data. Specifically, the access controller 172 of the IMAC instructs the thumbnail matching module 184 to search a same image for the scanned image data.

Specifically, the thumbnail matching module 184 generates a first thumbnail from the image data stored in the MEM at step 45a. The thumbnail matching module 184 also generates a second thumbnail from the image data in the generated file of the user folder.

Then, the thumbnail matching module 184 compares the first and second thumbnail whether the first and second thumbnail are the same image at step 45b.

If the thumbnail matching module 184 transmits information that no same image is found to the system controller 1 at step 45b, the system controller 1 refers management data set in step 43 to display preview or thumbnail view for the image data not stored in the image forming apparatus MF1.

If a preview is designated in the management data, a preview of image data stored in the MEM is displayed on the LCD touch panel 21 at steps 45c and 45d. If a thumbnail view is designated in the management data, a thumbnail view of image data stored in the MEM is displayed on the LCD touch panel 21 at steps 45c and 45e.

If the thumbnail matching module 184 transmits information that the same image is found to the system controller 1 at step 45b, the system controller 1 does not display a preview or thumbnail on the LCD touch panel 21.

If the thumbnail matching module 184 transmits information that same image is found to the system controller 1 at step 45b, the process goes to step 45f, and thereby the preview or thumbnail view of the image data is not displayed on the LCD touch panel 21.

Accordingly, a user can recognize which image data is already stored in the image forming apparatus MF1 with the preview or thumbnail view displayed on the LCD touch panel 21. In other words, if a same image data is found, the preview or thumbnail view is not displayed on the LCD touch panel 21, and if a same image data is not found, the preview or thumbnail view is displayed on the LCD touch panel 21.

At step 45f, the system controller 1 instructs the IMAC to search a security mark for the scanned image data stored in the MEM.

The access controller 172 of the IMAC instructs the mark detection module 182 to search a security mark for the scanned image data. The mark detection module 182 extracts an image on security mark area of the scanned image data stored in the MEM, and compares such extracted image with a security mark registered in the HDD whether the two images have an identical image at step 45f.

For example, the image forming apparatus MF1 is provided with an optical character reader (not shown) to scan a security mark, which may be on document image.

At step 46, if a user presses a store key on the LCD touch panel 21, the image data in the MEM is written in the file generated at step 43.

If the security mark is detected at step 48, the management data is added with “confirmation view not allowed” for image data in the file at step 49.

If the security mark is not detected at step 48, the management data is added with “confirmation view allowed” at step 50.

Accordingly, information having a classified status may not be displayed on the LCD touch panel 21, by which an information security can be improved.

If the store key is not pressed at step 46, the process goes to step 47.

If the system controller 1 receives an instruction of reading another image, the above-described steps 44 and subsequent steps are repeated.

FIG. 11 is referred again for step 20 and subsequent steps.

When the user touches the file selection key on the “copy server” view (FIG. 12) at step 20, the system controller 1 conducts a file selection at step 21.

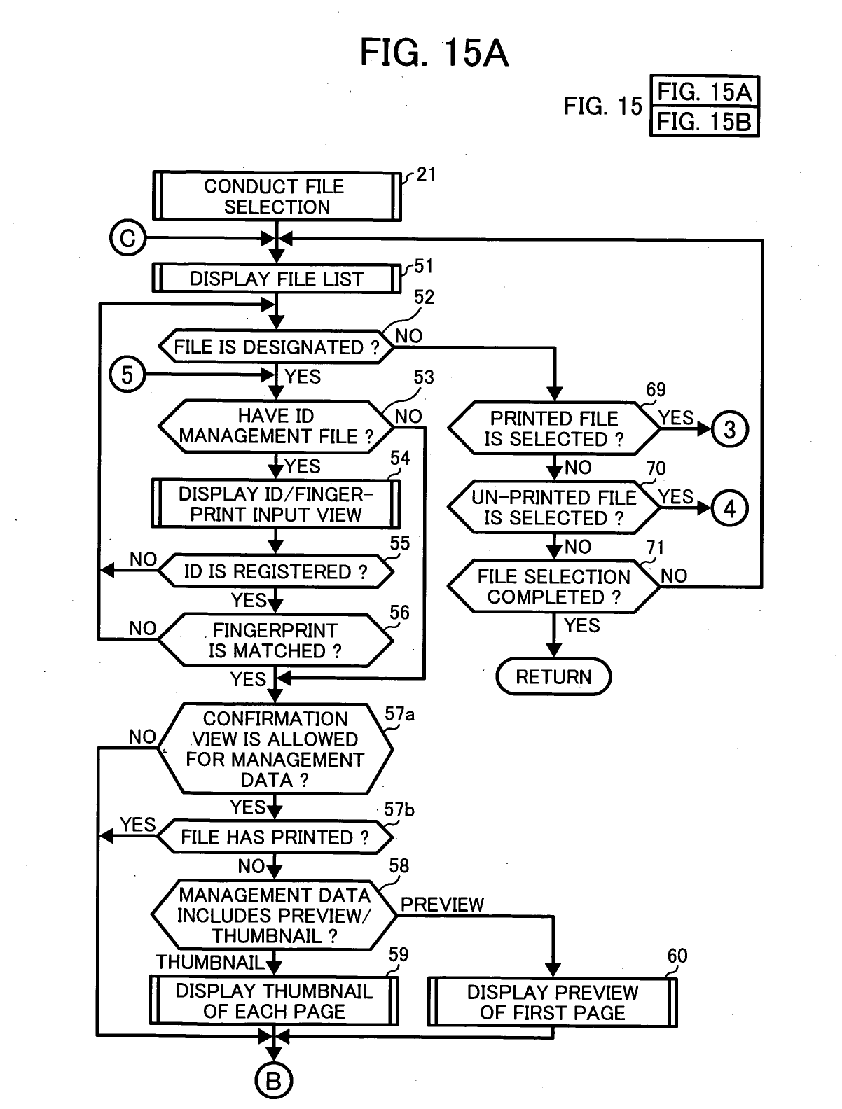

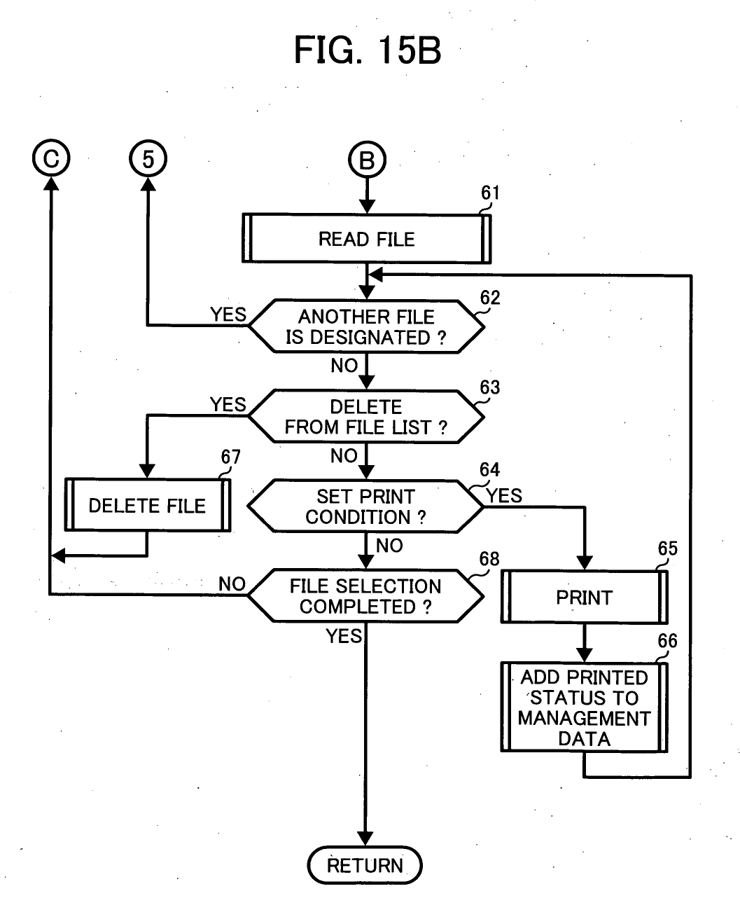

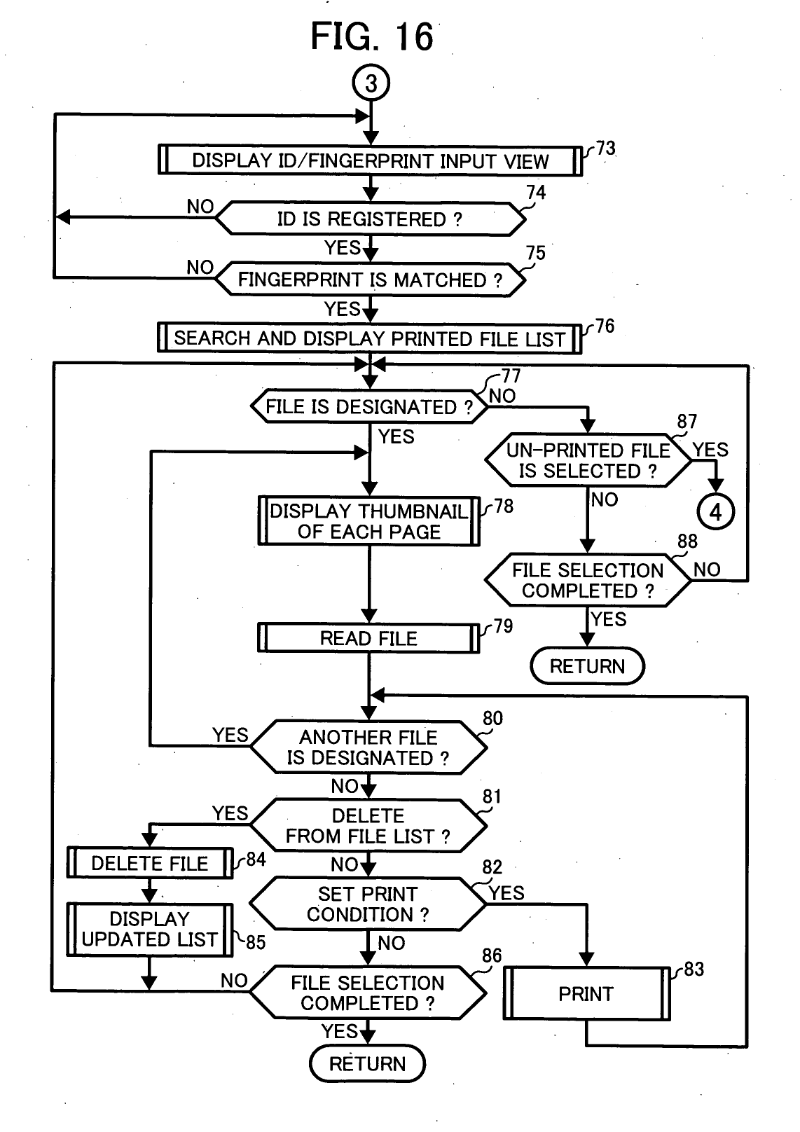

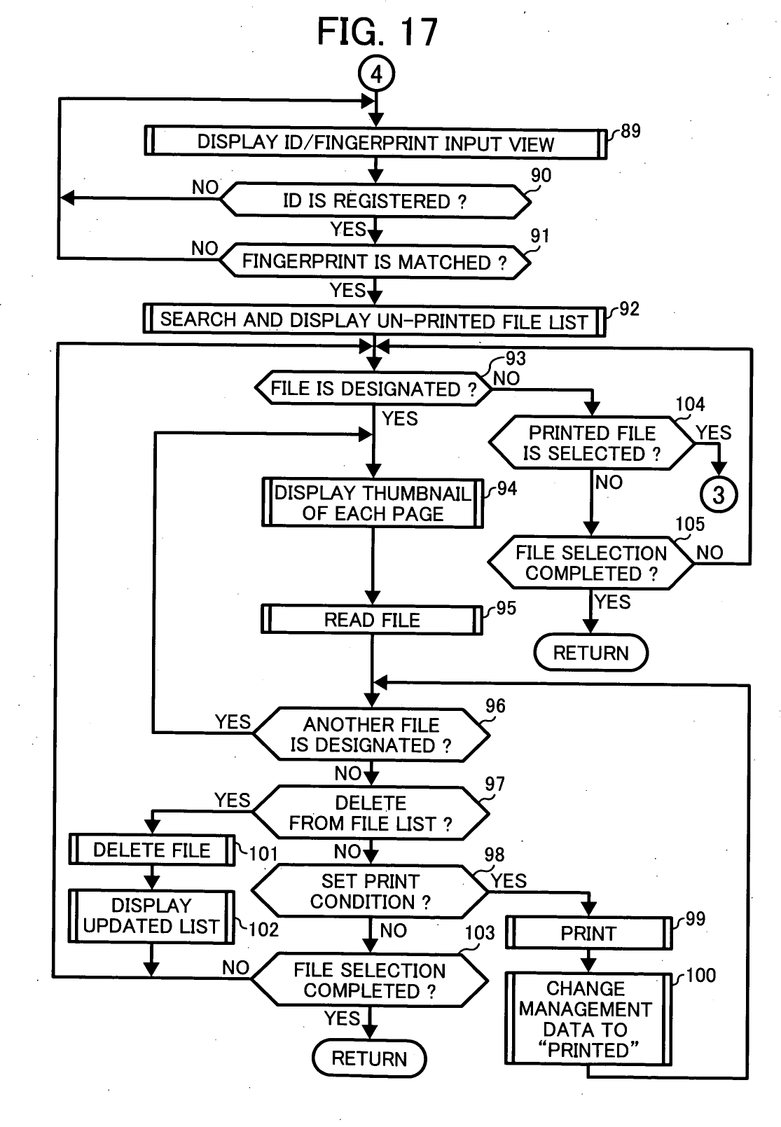

FIGS. 15A and 15B (or, collectively FIG. 15) are flow charts for explaining (according to an example embodiment of the present invention) a process of file selection at step 21 in detail. The file selection includes steps 51 to 68 as shown in FIG. 15.

At step 21, the LCD touch panel 21 of the operation panel 20 displays a user folder in the HDD.

When the user designates (i.e., touches) a folder on the LCD touch panel 21, a file list in the folder is displayed on the LCD touch panel 21 at step 51.

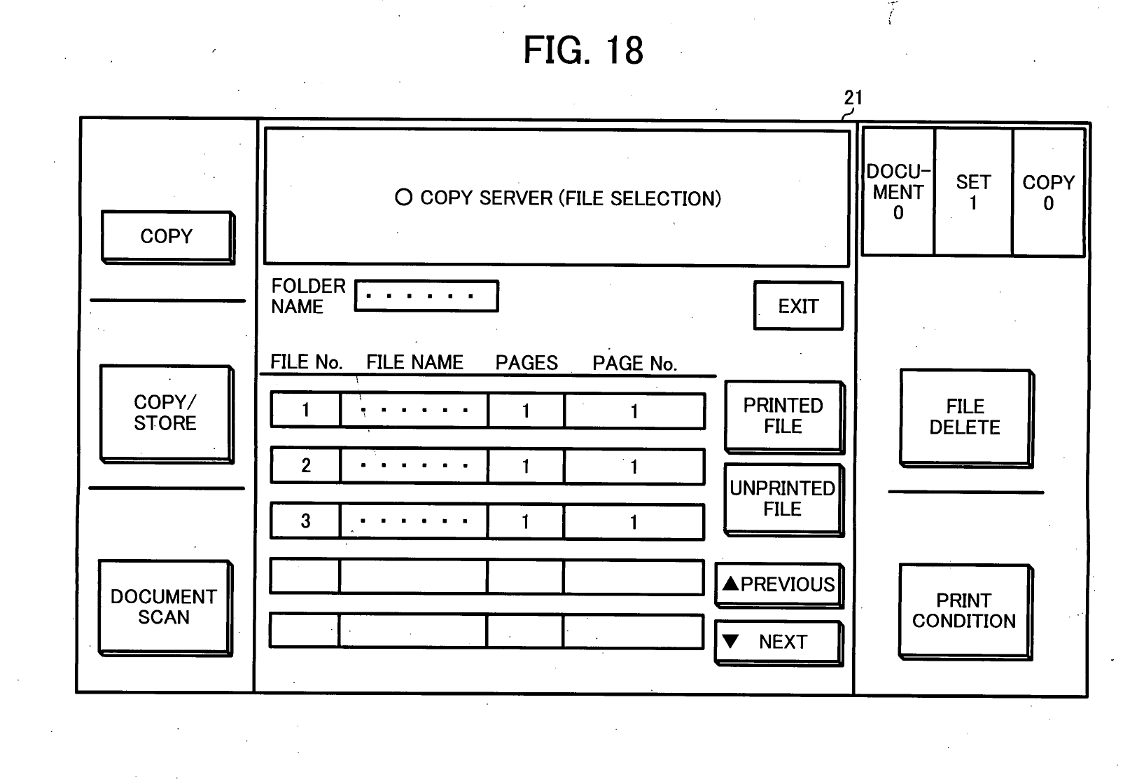

FIG. 18 is a schematic screen view (according to an example embodiment of the present invention) showing one example view on the LCD touch panel 21 when the file list is displayed on the LCD touch panel 21. The LCD touch panel 21 displays the file list in one folder as one example.

A user can select and change mode by pressing a key on the LCD touch panel 21. For example, when the user touch an exit key, the LCD touch panel 21 returns to a view displaying the user folder in the HDD.

As shown in FIG. 18, a plurality of files in the folder can be displayed with a given order such as file number order. For example, the plurality of files may be displayed with a registration order defined by year/month/date information. The file list can be displayed with other information such as total page number, for example.

From the “copy server” view shown in FIG. 18, the user can designate file number and page number, for example. If more than five files are found in one folder, the user can display not-displayed file information by scrolling the copy server view with a scroll key (i.e., previous or next key), for example.

When a user presses one file displayed on the LCD touch panel 21, such file can be inverted to “black” to indicate the user that such file is selected.

When one file is selected (or designated) at step 52, the system controller 1 refers to the management data of the designated file.

If the file includes an ID management data set at step 43 (FIG. 14), a user ID/fingerprint input view (not shown) is displayed over the file list shown in FIG. 18 at step 54. For example, the user ID/fingerprint input view may be displayed as a popup view over the file list.

If the user ID and/or fingerprint are input to the user ID/fingerprint input view, the ID matching module 181 checks (in the circumstance that it is desired to check the user ID) whether the input user ID is registered in the selected file at step 55. Alternatively, flow can bypass step 55 and proceed, e.g., directly from step 54 to step 56.

Then at step 56 (and assuming a circumstance in which it is desired to check the user's fingerprint) the fingerprint matching module 183 checks whether the input fingerprint is assigned to the user ID. Alternatively, flow can bypass step 56 and proceed, e.g., directly from step 55 (if the outcome is YES) to step 57a.

If the user ID and/or fingerprint are verified at steps 55 and/or 56, the system controller 1 checks whether the management data of the file includes a “confirmation view is allowed” at step 57a.

If the “confirmation view is allowed” is included in the management data of the file, the process goes to step 57b.

At step 57b, the system controller 1 checks whether the file is already printed (hereinafter, “file is already printed” is referred as “printed information”).

If the system controller 1 does not find the printed information, a preview or thumbnail view for the file is displayed on the LCD touch panel 21 at steps 58 and 59. The user can select a preview or thumbnail view depending on the management data of the file.

If the system controller 1 confirms that the management data of the file does not include “confirmation view is allowed” at step 57a, a preview or thumbnail view is not displayed on the LCD touch panel 21.

Accordingly, information having a classified status may not be displayed on the LCD touch panel 21, by which an information security can be improved.

Furthermore, even if the system controller 1 confirms that the management data of the file includes “confirmation view is allowed” at step 57a, a preview or thumbnail is not displayed on the LCD touch panel 21 if the system controller 1 confirms the printed information at step 57b.

At step 61, the system controller 1 conducts a reading of file.

At step 62, the system controller 1 checks whether the user designates another file.

If the user designates another file at step 62, the process goes back to step 53 and subsequent steps.

If the user does not designate another file at step 62, the process goes to step 63.

At step 63, the system controller 1 checks whether the user touches a file delete key to delete a file from the file list.

If the user press the file delete key on the LCD touch panel 21 at step 63, the system controller 1 deletes the file from the file list in the folder at step 67.

If the user does not touch the file delete key at step 63, the process goes to step 64.

If the user presses a print condition key on the LCD touch panel 21 at step 64, the LCD touch panel 21 changes a display view to a view for inputting print conditions at step 64.

If the user sets print conditions at step 64 and presses the start key 24, the image forming apparatus MF1 printouts an image of the designated file based on the print conditions at step 65. After the printing, the management data is added with “printed information” at step 66.

If the user does not set print conditions at step 64, the system controller checks whether the file selection is completed at step 68.

When a file is not selected (or designated) at step 52 in FIG. 15, the system controller 1 checks whether the user touches a printed file key (see FIG. 18) on the LCD touch panel 21 at step 69 (FIG. 15).

If the user touches a printed file key (see FIG. 18) on the LCD touch panel 21 at step 52, the system controller 1 executes step 73 shown in FIG. 16, where FIG. 16 is another flowchart (according to an example embodiment of the present invention) related to file selection.

At step 73, the system controller 1 displays a user ID/fingerprint input view (not shown) over the file list. For example, the user ID/fingerprint input view may be displayed as a popup view over the file list shown in FIG. 18.

If the user ID and/or fingerprint are input to the user ID/fingerprint input view, the ID matching module 181 (if need be) checks whether the input user ID is registered in files at step 74.

Then, the fingerprint matching module 183 (if need be) checks whether the input fingerprint is assigned to the user ID at step 75.

If the user ID and/or fingerprint are verified at steps 74 and/or 75, the system controller 1 searches files having “printed information” in management data from files stored in a user folder, which is presently selected, and changes a display view to a updated file list view showing files having printed information at step 76.

At step 77, the system controller 1 checks whether the user designates a file from the updated file list.

If the file in the updated file list is designated at step 77, a page view of the designated file is displayed on the LCD touch panel 21 as thumbnail view at step 78. In stead of thumbnail view showing each page, a preview showing first page can be displayed.

At step 79, the system controller 1 conducts a reading of file.

At step 80, the system controller 1 checks whether the user designates another file. If the user designates another file at step 80, the process goes back to step 78 and subsequent steps.

If the user does not designate another file at step 80, the process goes to step 81.

At step 81, the system controller 1 checks whether the user touches a file delete key to delete a file from the file list.

If the user touches the file delete key at step 81, the system controller 1 deletes the file from the file list in the folder at step 84, and an updated file list, which has deleted the file, is displayed on the LCD touch panel 21 at step 85.

If the user does not touch the file delete key at step 81, the process goes to step 82.

If the user touches the print condition key on the LCD touch panel 21 at step 82, the LCD touch panel 21 changes a display view to a view for inputting print conditions at step 82.

If the user sets printing conditions at step 82 and presses the start key 24, the image forming apparatus MF1 printouts an image of the designated file based on the print conditions at step 83. After the printing, the process goes back to step 80.

If the user does not set print conditions at step 82, the system controller 1 checks whether the file selection is completed at step 86. For example, if the user touches a copy key, copy/store key, or document scan key, the file selection is completed.

Furthermore, if the user does not designate a file at step 77, the process goes to step 87.

At step 87, the system controller 1 checks whether the user touches the un-printed file key (FIG. 18) on the LCD touch panel 21.

If the user touches the un-printed file key (see FIG. 18) at step 87, the system controller 1 executes step 89 shown in FIG. 17, where FIG. 17 is another flowchart (according to an example embodiment of the present invention) related to file selection.

Similarly, if the user does not touch a printed file key (see FIG. 18) on the LCD touch panel 21 at step 69 (FIG. 15A) and touches a un-printed file key (see FIG. 18) on the LCD touch panel 21, the process goes to step 89.

At step 89, the system controller 1 displays a user ID/fingerprint input view (not shown) over the file list. For example, the user ID/fingerprint input view may be displayed as a popup view over the file list shown in FIG. 18.

If the user ID and/or fingerprint are input to the user ID/fingerprint input view, the ID matching module 181 (if need be) checks whether the input user ID is registered in files at step 90.

Then, the fingerprint matching module 183 (if need be) checks whether the input fingerprint is assigned to the user ID at step 91.

If the user ID and/or fingerprint are verified at steps 90 and/or 91, the system controller 1 searches files having “un-printed information” in management data from files stored in a user folder, which is presently selected, and changes a display view to a updated file list view showing files having un-printed information at step 92. The un-printed information means that a file has not been printed previously.

At step 93, the system controller 1 checks whether the user designates a file from the updated file list.

If the file in the updated file list is designated at step 93, a page view of the designated file is displayed on the LCD touch panel 21 as thumbnail view at step 94. In stead of thumbnail view showing each page, a preview showing first page can be displayed.

At step 95, the system controller 1 conducts a reading of file.

At step 96, the system controller checks whether the user designates another file. If the user designates another file at step 96, the process goes back to step 94 and subsequent steps.

If the user does not designate another file at step 96, the process goes to step 97.

At step 97, the system controller 1 checks whether the user touches a file delete key to delete a file from the file list.

If the user touches the file delete key at step 97, the system controller 1 deletes the file from the file list in the folder at step 101, and an updated file list, which has deleted the file, is displayed on the LCD touch panel 21 at step 102.

If the user does not touch the file delete key at step 97, the process goes to step 98.

If the user touches the print condition key on the LCD touch panel 21 at step 98, the LCD touch panel 21 changes a display view to a view for inputting print conditions at step 98.

If the user sets printing conditions at step 98 and presses the start key 24, the image forming apparatus MF1 printouts an image of the designated file based on the print conditions at step 99. After the printing, printed information is added to the management data of the file at step 100.

If the user does not set print conditions at step 98, the system controller 1 checks whether the file selection is completed at step 103. For example, if the user touches a copy key, copy/store key, or document scan key, the file selection is completed.

Numerous additional modifications and variations are possible in light of the above teachings. It is therefore to be understood that within the scope of the appended claims, the disclosure of the present invention may be practiced otherwise than as specifically described herein.

1. An image forming apparatus, comprising:
a memory configured to store image data;
a display unit to display at least one of information and a view of image data;
a condition setting unit to receive designating information by which a designation is made of at least a subset of the image data stored in the memory;
a printing unit configured to print an image, corresponding to the designated image data, on a recording medium; and
a controller configured to assign printed information to the designated image data stored in the memory when an image of the designated image data is printed by the printing unit, and to selectively display a view of the designated image data on the display unit.

2. The image forming apparatus according to claim 1, wherein the controller omits displaying on the display unit a view of the designated image data when printed information has been assigned thereto.

3. The image forming apparatus according to claim 1, wherein the controller displays a view of the designated image data on the display unit when no printed information has been assigned to the designated image data.

4. The image forming apparatus according to claim 1, further comprising an image processing unit configured to process the image data, the image processing unit including:
a first register configured to register user identification for the image data stored in the memory as security information; and
a user identifier configured to verify user identification information, input to the image forming apparatus, by comparing the user identification information and the security information registered by the first register; and
wherein the controller selectively displays a view of the designated image data on the display unit based on the designating information and a verification result of the user identifier.

5. The image forming apparatus according to claim 4, wherein the controller displays a view of the designated image data when the user identifier verifies the user identification information for the designated image data.

6. The image forming apparatus according to claim 4, wherein the controller omits displaying a view of the designated image data when the user identifier is unable to verify the user identification information for the designated image data.

7. The image forming apparatus according to claim 1, further comprising:
a scanner configured to scan a document and generate image data corresponding thereto; and
an image processing unit configured to process the image data, the image processing unit including the following,
a mark identifier configured to detect a mark on the scanned image, the mark representing security information of the document, and
a second register configured to register the security information for the scanned image data to be stored in the memory;
wherein the controller selectively displays a view of the scanned image data on the display unit depending on a detection result of the mark identifier.

8. The image forming apparatus according to claim 7, wherein the controller omits displaying a view of the scanned image data on the display unit when the mark identifier detects the mark on the scanned image.

9. The image forming apparatus according to claim 7, wherein the controller displays a view of the scanned image data on the display unit when the mark identifier is unable to detect the mark on the scanned image.

10. The image forming apparatus according to claim 7, wherein the image processing unit further comprising an image matching unit configured to search for image data in the memory which matches the scanned image data, and wherein the controller selectively displays a view of the scanned image data on the display unit depending on a comparison result by the image matching unit.

11. The image forming apparatus according to claim 10, wherein the controller is further operable to do at least one of the following:
omit displaying a view of the scanned image data on the display unit when the image matching unit confirms as being present in the memory image data which is identical to the scanned image data; and
display a view of the scanned image data on the display unit when the image matching unit confirms as not being present in the memory image data which is identical to the scanned image data.

12. The image forming apparatus according to claim 1, wherein the condition setting unit includes at least one of:
a printed data designator; and
an unprinted data designator;
wherein the controller selectively displays a view of the designated image data on the display unit when the printed data designator and unprinted data designator, resepectively, is selected.

13. The image forming apparatus according to claim 4, wherein the user identification information includes at least one of a user name, user number, and fingerprint.

14. An image forming apparatus, comprising:
storage means for storing image data;
display means for displaying at least one of information and a view of image data;
DSG_RX means for receiving designating information by which a designation is made of at least a subset of the image data stored in the storage means;
PRT means for printing an image, corresponding to the designated image data, on a recording medium; and
CTL means for assigning printed information to the designated image data stored in the storage means when an image of the designated image data is printed by the PRT means, and for selectively displaying a view of the designated image data on the display means.

15. A method of outputting an image, the method comprising:
storing image data in a memory;
receiving designating information by which a designation is made of at least a subset of the image data stored in the memory;
printing an image corresponding to the designated image data;
assigning printed information to the designated image data stored in the memory according to the step of printing;
omitting displaying a view of the designated image data when printed information has been assigned thereto; and
displaying a view of the designated image data when no printed information has been assigned to the designated image data.

16. The method according to claim 15, further comprising:
registering user identification in the memory for the image data stored therein as security information; and
verifying user identification information by comparing received user identification information and the registered security information; and
wherein the step of selectively displaying includes the following,
displaying a view of the designated image data when the step of verifying verifies the user identification information for the designated image data, and
omitting displaying a view of the designated image data when the step of verifying is unable to verify the user identification information for the designated image data.

17. The method according to claim 15, further comprising:
scanning a document and generating image data corresponding thereto;
detecting a mark on the scanned image, the mark representing security information of the document, and
registering the security information for the scanned image data;
wherein the step of selectively displaying includes the following,
omitting displaying a view of the scanned image data when the mark identifier detects the mark on the scanned image, and
displaying a view of the scanned image data when the detecting step is unable to detect the mark on the scanned image.

18. The method according to claim 17, further comprising:
searching for image data in the memory which matches the scanned image data; and
wherein the step of selectively displaying includes the following,
omitting displaying a view of the scanned image data when the searching step confirms as being present in the memory image data which is identical to the scanned image data, and
displaying a view of the scanned image data when the searching step confirms as not being present in the memory image data which is identical to the scanned image data.

19. The method according to claim 15, wherein the step of selectively displaying includes at least one of:
selectively displaying a view of the designated image data when a printed data designator is selected; and
selectively displaying a view of the designated image data when an unprinted data designator is selected.

20. The method according to claim 16, wherein the user identification information includes at least one of a user name, user number, and fingerprint.
